(19) United States
(12) Patent Application Publication
(10) Pub. No.: US 2017/0168667 A1
(43) Pub. Date: Jun. 15, 2017

(54) MOBILE TERMINAL AND METHOD FOR CONTROLLING THE SAME

(71) Applicant: LG ELECTRONICS INC., Seoul (KR)

(72) Inventors: Bongjeong JEON, Seoul (KR); Insuk KIM, Seoul (KR); Sesook OH, Seoul (KR); Jian CHOI, Seoul (KR); Namki KIM, Seoul (KR)

(73) Assignee: LG ELECTRONICS INC., Seoul (KR)

(21) Appl. No.: 15/247,152

(22) Filed: Aug. 25, 2016

(30) Foreign Application Priority Data
Dec. 15, 2015 (KR) 10-2015-0179563

(51) Int. Cl. G06F 3/0482; G06F 3/0481; G06F 3/0488

(52) U.S. Cl. CPC G06F 3/0482; G06F 3/04883; G06F 3/04817; H04W 88/02

(57) ABSTRACT

A mobile terminal including a wireless communication processor configured to provide wireless communication; a touchscreen configured to display a home screen page; and a controller configured to display an Internet Of Things (IOT) page instead of the home screen page in response to a preset touch input on the home screen page, wherein the IOT page includes at least one icon for executing an application on a specific external device, and in response to an execution request of the displayed icon on the IOT page, transmit information associated with the application to the specific external device through the wireless communication processor to execute the application on the specific external device.

### CROSS-REFERENCE TO RELATED APPLICATION

Pursuant to 35 U.S.C. §119(a), this application claims the benefit of earlier filing date and right of priority to Korean Application No. 10-2015-0179563, filed on Dec. 15, 2015, the contents of which is incorporated by reference herein in its entirety.

### BACKGROUND OF THE INVENTION

1. Field of the Invention

The present disclosure relates to a mobile terminal and corresponding method in an internet of things (IOT) environment.

2. Description of the Related Art

Terminals can be classified into two types, such as a mobile or portable terminal and a stationary terminal based on its mobility. Furthermore, the mobile terminal can be further classified into two types, such as a handheld terminal and a vehicle mount terminal based on whether or not it can be directly carried by a user.

The functionality of the mobile terminal has been diversified. For example, there are functions of data and voice communication, photo capture and video capture through a camera, voice recording, music file reproduction through a speaker system, and displaying an image or video on the display unit. Some terminals may additionally perform an electronic game play function or perform a multimedia play function. In particular, recent terminals may receive multicast signals for providing video contents such as broadcasts, videos, television programs, or the like.

As it becomes multifunctional, for example, such a terminal can capture still images or moving images, play music or video files, play games, receive broadcast and the like, so as to be implemented as an integrated multimedia player. In order to support and enhance the functions of the terminal, the improvement of structural or software elements of the terminal may be taken into consideration.

Further, in recent years, technologies for controlling things such as home appliances or the like from a remote distance through the Internet have been developed. As part of the developments, more convenient methods for allowing a mobile terminal to control things through the Internet have been developed.

### SUMMARY OF THE INVENTION

An aspect of the present disclosure is to provide a mobile terminal capable of allowing a user to more conveniently use the environment of the internet of things.

Furthermore, another aspect of the present disclosure is to provide a user interface capable of establishing the environment of the internet of things in consideration of user's convenience.

Still another aspect of the present disclosure is to collect and provide information associated with the environment of the internet of things.

A mobile terminal according to an embodiment of the present disclosure may include a display unit configured to display any one home screen page among at least one home screen page, and a controller configured to control the display unit to display a page of the internet distinguished from the at least one home screen page instead of the any one home screen page based on a touch input to the display unit, wherein the controller transmits information associated with the at least one application to a specific external device through communication to execute the at least one application on the specific external device upon receiving an execution request for at least one application contained in the page of the internet of things.

According to a control method of a mobile terminal according to another embodiment of the present disclosure, the method may include displaying any one home screen page among at least one home screen page on a display unit, displaying a page of the internet distinguished from the at least one home screen page instead of the any one home screen page based on a touch input to the display unit, and transmitting information associated with the at least one application to a specific external device to execute the at least one application on the specific external device upon receiving an execution request for at least one application contained in the page of the internet.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is a block diagram illustrating a mobile terminal associated with the present disclosure;

FIGS. 1B and 1C are conceptual views in which an example of a mobile terminal associated with the present disclosure is seen from different directions;

FIG. 1D is a conceptual view illustrating the environment of the internet of things according to an embodiment of the present disclosure;

FIG. 2 is a flow chart illustrating a method of providing a page of the internet of things to control the environment of the internet of things in a mobile terminal according to an embodiment of the present disclosure;

FIG. 3 is a conceptual view illustrating a home screen page;

FIG. 4 is a conceptual view illustrating a page of the internet of things and a home screen page in a mobile terminal according to an embodiment of the present disclosure;

FIGS. 5A and 5B are conceptual views illustrating a method of entering a page of the internet of things;

FIGS. 6A and 6B are conceptual views illustrating a method of executing an application on a page of the internet of things;

FIGS. 7A through 7C are conceptual views illustrating a method of adding or deleting an application contained in a page of the internet of things;

FIGS. 8A and 8B are conceptual views illustrating a method of changing an external device connected to an application contained in a page of the internet of things;

FIGS. 9A and 9B are conceptual views illustrating the characteristics of a notification window displayed on a page of the internet of things and a home screen page;

FIGS. 10A and 10B are conceptual view illustrating a method of allowing an application being executed in a mobile terminal without being connected to an external device to be connected and executed to the external device;

FIGS. 11A through 12 are conceptual views illustrating a feature associated with a folder image contained in a page of the internet of things; and

FIG. 13 is a conceptual view illustrating a method of controlling a case where a connection to an external device is ended for an application being connected and executed to the external device.

### DETAILED DESCRIPTION OF THE INVENTION

Hereinafter, an embodiment disclosed in the present disclosure will be described in detail with reference to the accompanying drawings. For the sake of brief description with reference to the drawings, the same or equivalent components will be provided with the same reference numbers, and description thereof will not be repeated. A suffix “module” and “unit” used for constituent elements disclosed in the following description is merely intended for easy description of the specification, and the suffix itself does not give any special meaning or function. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that, although the terms first, second, etc. may be used herein to describe various elements, these elements should not be limited by these terms. These terms are only used to distinguish one element from another. When an element is referred to as being “connected with” another element, the element can be directly connected with the other element or intervening elements may also be present. In contrast, when an element is referred to as being “directly connected with” another element, there are no intervening elements present.

A singular representation may include a plural representation as far as it represents a definitely different meaning from the context. Terms “include” or “has” used herein should be understood that they are intended to indicate an existence of several components or several steps, disclosed in the specification, and it may also be understood that part of the components or steps may not be included or additional components or steps may further be included.

Mobile terminals described herein may include cellular phones, smart phones, laptops, digital broadcasting terminals, personal digital assistants (PDAs), portable multimedia players (PMPs), navigators, slate PCs, tablet PCs, ultra books, wearable devices (for example, smart watches, smart glasses, head mounted displays (HMDs)), and the like. However, it may be easily understood by those skilled in the art that the configuration according to the exemplary embodiments of this specification can also be applied to stationary terminals such as digital TV, desktop computers and the like, excluding a case of being applicable only to the mobile terminals.

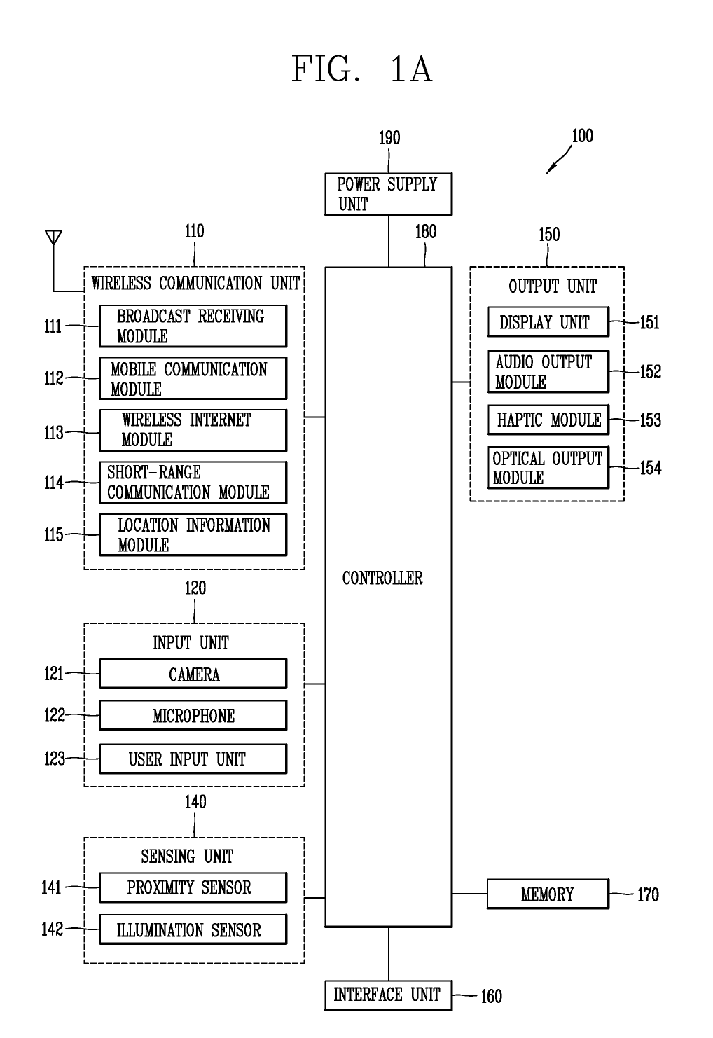

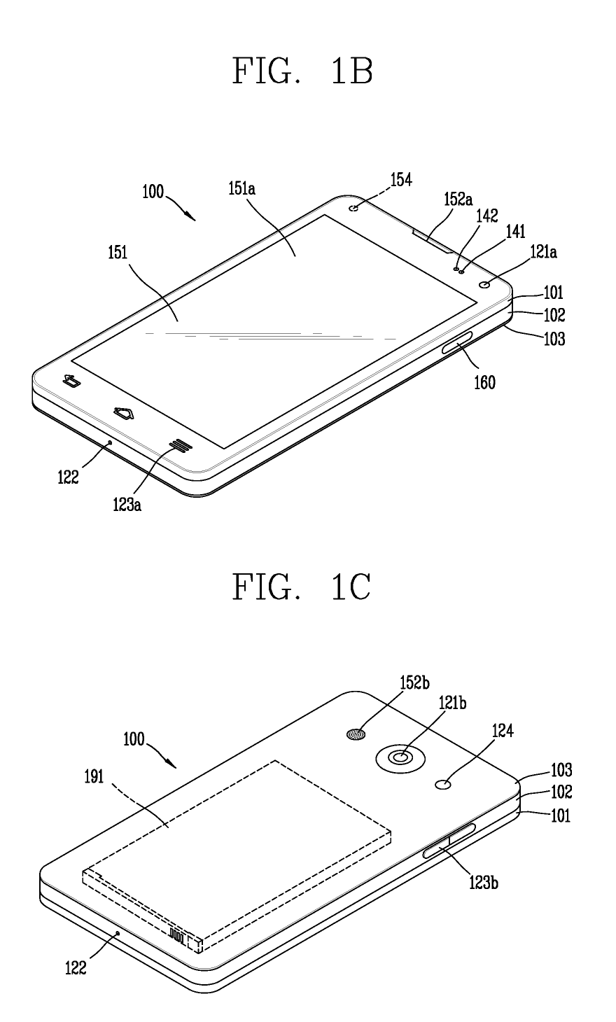

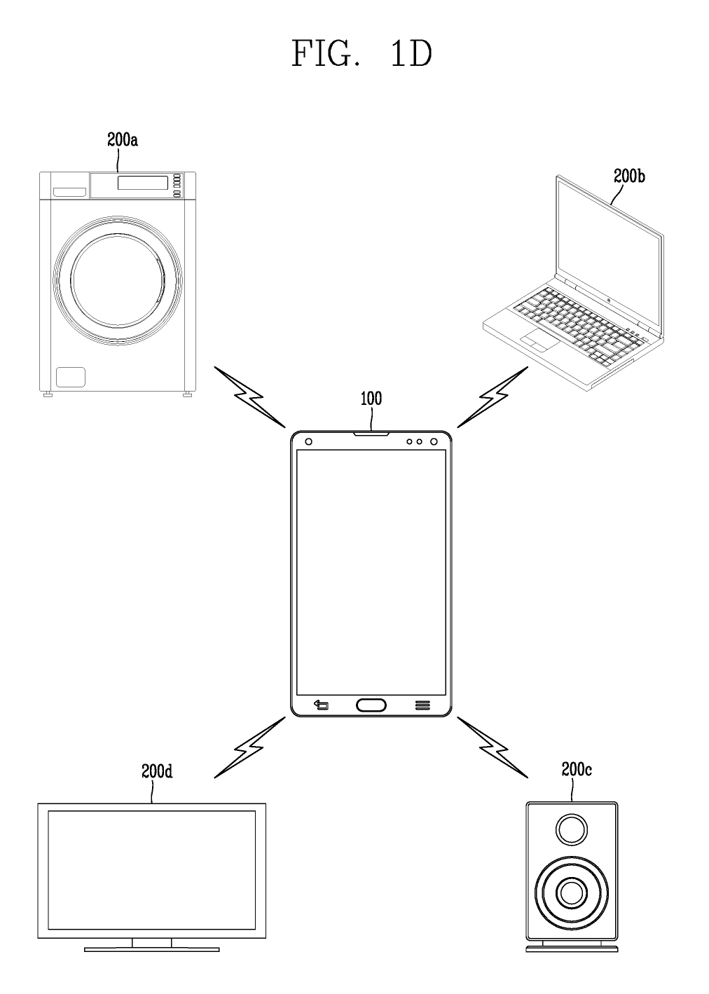

Referring to FIGS. 1A through 1C, FIG. 1A is a block diagram of a mobile terminal in accordance with the present disclosure, FIGS. 1B and 1C are conceptual views of one example of the mobile terminal, viewed from different directions.

The mobile terminal 100 may include components, such as a wireless communication unit 110, an input unit 120, a sensing unit 140, an output unit 150, an interface unit 160, a memory 170, a controller 180, a power supply unit 190 and the like. FIG. 1A illustrates the mobile terminal having various components, but implementing all of the illustrated components is not a requirement. Greater or fewer components may alternatively be implemented.

In more detail, the wireless communication unit 110 of those components may typically include one or more modules which permit wireless communications between the mobile terminal 100 and a wireless communication system, between the mobile terminal 100 and another mobile terminal 100, or between the mobile terminal 100 and a network within which another mobile terminal 100 (or an external server) is located.

For example, the wireless communication unit 110 may include at least one of a broadcast receiving module 111, a mobile communication module 112, a wireless Internet module 113, a short-range communication module 114, a location information module 115 and the like. The input unit 120 may include a camera 121 for inputting an image signal, a microphone 122 or an audio input module for inputting an audio signal, or a user input unit 123 (for example, a touch key, a push key (or a mechanical key), etc.) for allowing a user to input information. Audio data or image data collected by the input unit 120 may be analyzed and processed by a user's control command.

The sensing unit 140 may include at least one sensor which senses at least one of internal information of the mobile terminal, a surrounding environment of the mobile terminal and user information. For example, the sensing unit 140 may include a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, refer to the camera 121), a microphone 122, a battery gage, an environment sensor (for example, a barometer, a hygrometer, a thermometer, a radiation detection sensor, a thermal sensor, a gas sensor, etc.), and a chemical sensor (for example, an electronic nose, a health care sensor, a biometric sensor, etc.). Further, the mobile terminal disclosed herein may utilize information in such a manner of combining information sensed by at least two sensors of those sensors.

The output unit 150 may be configured to output an audio signal, a video signal or a tactile signal. The output unit 150 may include a display unit 151, an audio output module 152, a haptic module 153, an optical output module 154 and the like. The display unit 151 may have an inter-layered structure or an integrated structure with a touch sensor so as to implement a touch screen. The touch screen may provide an output interface between the mobile terminal 100 and a user, as well as functioning as the user input unit 123 which provides an input interface between the mobile terminal 100 and the user.

The interface unit 160 may serve as an interface with various types of external devices connected with the mobile terminal 100. The interface unit 160, for example, may include wired or wireless headset ports, external power supply ports, wired or wireless data ports, memory card ports, ports for connecting a device having an identification module, audio input/output (I/O) ports, video I/O ports, earphone ports, or the like. The mobile terminal 100 may execute an appropriate control associated with a connected external device, in response to the external device being connected to the interface unit 160.

Furthermore, the memory 170 may store a plurality of application programs (or applications) executed in the mobile terminal 100, data for operations of the mobile terminal 100, instruction words, and the like. At least some of those application programs may be downloaded from an external server via wireless communication. Some others of those application programs may be installed within the mobile terminal 100 at the time of being shipped for basic functions of the mobile terminal 100 (for example, receiving a call, placing a call, receiving a message, sending a message, etc.). Further, the application programs may be stored in the memory 170, installed in the mobile terminal 100, and executed by the controller 180 to perform an operation (or a function) of the mobile terminal 100.

The controller 180 can typically control an overall operation of the mobile terminal 100 in addition to the operations associated with the application programs. The controller 180 can provide or process information or functions appropriate for a user by processing signals, data, information and the like, which are input or output by the aforementioned components, or activating the application programs stored in the memory 170.

Furthermore, the controller 180 can control at least part of the components illustrated in FIG. 1, in order to drive the application programs stored in the memory 170. In addition, the controller 180 can drive the application programs by combining at least two of the components included in the mobile terminal 100 for operation.

The power supply unit 190 may receive external power or internal power and supply appropriate power required for operating respective elements and components included in the mobile terminal 100 under the control of the controller 180. The power supply unit 190 may include a battery, and the battery may be an embedded battery or a replaceable battery.

At least part of those elements and components may be combined to implement operation and control of the mobile terminal or a control method of the mobile terminal according to various exemplary embodiments described herein. Also, the operation and control or the control method of the mobile terminal can be implemented in the mobile terminal in such a manner of activating at least one application program stored in the memory 170.

Hereinafter, each aforementioned component will be described in more detail with reference to FIG. 1A, prior to explaining various exemplary embodiments implemented by the mobile terminal 100 having the configuration. First, the wireless communication unit 110 will be described. The broadcast receiving module 111 of the wireless communication unit 110 may receive a broadcast signal and/or broadcast associated information from an external broadcast managing entity via a broadcast channel. The broadcast channel may include a satellite channel and a terrestrial channel. At least two broadcast receiving modules 111 may be provided in the mobile terminal 100 to simultaneously receive at least two broadcast channels or switch the broadcast channels.

The mobile communication module 112 may transmit/receive wireless signals to/from at least one of network entities, for example, a base station, an external mobile terminal, a server, and the like, on a mobile communication network, which is constructed according to technical standards or transmission methods for mobile communications (for example, Global System for Mobile Communication (GSM), Code Division Multi Access (CDMA), Wideband CDMA (WCDMA), High Speed Downlink Packet Access (HSDPA), High Speed Uplink Packet Access (HSUPA), Long Term Evolution (LTE), Long Term Evolution-Advanced (LTE-A), etc.)

Here, the wireless signals may include audio call signal, video (telephony) call signal, or various formats of data according to transmission/reception of text/multimedia messages. The wireless Internet module 113 denotes a module for wireless Internet access. This module may be internally or externally coupled to the mobile terminal 100. The wireless Internet module 113 may transmit/receive wireless signals via communication networks according to wireless Internet technologies.

Examples of such wireless Internet access may include Wireless LAN (WLAN), Wireless Fidelity (Wi-Fi) Direct, Digital Living Network Alliance (DLNA), Wireless Broadband (Wibro), Worldwide Interoperability for Microwave Access (Wimax), High Speed Downlink Packet Access (HSDPA), High Speed Uplink Packet Access (HSUPA), Long Term Evolution (LTE), Long Term Evolution-Advanced (LTE-A), and the like. The wireless Internet module 113 may transmit/receive data according to at least one wireless Internet technology within a range including even Internet technologies which are not aforementioned.

From the perspective that the wireless Internet accesses according to Wibro, HSDPA, GSM, CDMA, WCDMA, LET and the like are executed via a mobile communication network, the wireless Internet module 113 which performs the wireless Internet access via the mobile communication network may be understood as a type of the mobile communication module 112.

The short-range communication module 114 denotes a module for short-range communications. Suitable technologies for implementing the short-range communications may include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, and the like. The short-range communication module 114 may support wireless communications between the mobile terminal 100 and a wireless communication system, between the mobile terminal 100 and another mobile terminal 100, or between the mobile terminal and a network where another mobile terminal 100 (or an external server) is located, via wireless personal area networks.

Here, the another mobile terminal 100 may be a wearable device, for example, a smart watch, a smart glass or a head mounted display (HMD), which can exchange data with the mobile terminal 100 (or to cooperate with the mobile terminal 100). The short-range communication module 114 may sense (recognize) a wearable device, which can communicate with the mobile terminal), near the mobile terminal 100. In addition, when the sensed wearable device is a device which is authenticated to communicate with the mobile terminal 100 according to an embodiment of the present disclosure, the controller 180 can transmit at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

The location information module 115 denotes a module for detecting or calculating a position of the mobile terminal. An example of the location information module 115 may include a Global Position System (GPS) module or a Wi-Fi module. For example, when the mobile terminal uses the GPS module, a position of the mobile terminal can be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. According to the need, the location information module 115 may perform any function of the other modules of the wireless communication unit 110 to obtain data for the location of the mobile terminal in a substitutional or additional manner. The location information module 115 may be a module used to obtain the location (or current location) of the mobile terminal, and may not be necessarily limited to a module for directly calculating or obtaining the location of the mobile terminal.

Next, the input unit 120 may be configured to provide an audio or video signal (or information) input to the mobile terminal or information input by a user to the mobile terminal. For the input of the audio information, the mobile terminal 100 may include one or a plurality of cameras 121. The camera 121 may process image frames of still pictures or video obtained by image sensors in a video call mode or a capture mode. The processed image frames may be displayed on the display unit 151. Further, the plurality of cameras 121 disposed in the mobile terminal 100 may be arranged in a matrix configuration. By use of the cameras 121 having the matrix configuration, a plurality of image information having various angles or focal points may be input into the mobile terminal 100. Also, the plurality of cameras 121 may be arranged in a stereoscopic structure to acquire a left image and a right image for implementing a stereoscopic image.

The microphone 122 may process an external audio signal into electric audio data. The processed audio data may be utilized in various manners according to a function being executed in the mobile terminal 100 (or an application program being executed). Further, the microphone 122 may include assorted noise removing algorithms to remove noise generated in the course of receiving the external audio signal.

The user input unit 123 may receive information input by a user. When information is input through the user input unit 123, the controller 180 can control an operation of the mobile terminal 100 to correspond to the input information. The user input unit 123 may include a mechanical input element (or a mechanical key, for example, a button located on a front/rear surface or a side surface of the mobile terminal 100, a dome switch, a jog wheel, a jog switch, etc.), and a touch-sensitive input means. As one example, the touch-sensitive input means may be a virtual key, a soft key or a visual key, which is displayed on a touch screen through software processing, or a touch key which is disposed on a portion except for the touch screen. Further, the virtual key or the visual key may be displayable on the touch screen in various shapes, for example, graphic, text, icon, video or a combination thereof.

Further, the sensing unit 140 may sense at least one of internal information of the mobile terminal, surrounding environment information of the mobile terminal and user information, and generate a sensing signal corresponding to it. The controller 180 can control an operation of the mobile terminal 100 or execute data processing, a function or an operation associated with an application program installed in the mobile terminal based on the sensing signal. Hereinafter, description will be given in more detail of representative sensors of various sensors which may be included in the sensing unit 140.

First, a proximity sensor 141 refers to a sensor to sense presence or absence of an object approaching to a surface to be sensed, or an object disposed near a surface to be sensed, by using an electromagnetic field or infrared rays without a mechanical contact. The proximity sensor 141 may be arranged at an inner region of the mobile terminal covered by the touch screen, or near the touch screen. The proximity sensor 141 may have a longer lifespan and a more enhanced utility than a contact sensor.

The proximity sensor 141, for example, may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, the proximity sensor 141 may sense proximity of a pointer to the touch screen by changes of an electromagnetic field, which is responsive to an approach of an object with conductivity. In this instance, the touch screen (touch sensor) may be categorized into a proximity sensor.

Further, for the sake of brief explanation, a status that the pointer is positioned to be proximate onto the touch screen without contact will be referred to as ‘proximity touch,’ whereas a status that the pointer substantially comes in contact with the touch screen will be referred to as ‘contact touch.’ For the position corresponding to the proximity touch of the pointer on the touch screen, such position will correspond to a position where the pointer faces perpendicular to the touch screen upon the proximity touch of the pointer. The proximity sensor 141 may sense proximity touch, and proximity touch patterns (e.g., distance, direction, speed, time, position, moving status, etc.). Further, the controller 180 can process data (or information) corresponding to the proximity touches and the proximity touch patterns sensed by the proximity sensor 141, and output visual information corresponding to the process data on the touch screen. In addition, the controller 180 can control the mobile terminal 100 to execute different operations or process different data (or information) according to whether a touch with respect to the same point on the touch screen is either a proximity touch or a contact touch.

A touch sensor may sense a touch (or touch input) applied onto the touch screen (or the display unit 151) using at least one of various types of touch methods, such as a resistive type, a capacitive type, an infrared type, a magnetic field type, and the like. As one example, the touch sensor may be configured to convert changes of pressure applied to a specific part of the display unit 151 or a capacitance occurring from a specific part of the display unit 151, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors as described above, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180 or the controller 180 itself.

Further, the controller 180 can execute a different control or the same control according to a type of an object which touches the touch screen (or a touch key provided in addition to the touch screen). Whether to execute the different control or the same control according to the object which gives a touch input may be decided based on a current operating state of the mobile terminal 100 or a currently executed application program.

Meanwhile, the touch sensor and the proximity sensor may be executed individually or in combination, to sense various types of touches, such as a short (or tap) touch, a long touch, a multi-touch, a drag touch, a flick touch, a pinch-in touch, a pinch-out touch, a swipe touch, a hovering touch, and the like.

An ultrasonic sensor may be configured to recognize position information relating to a sensing object by using ultrasonic waves. The controller 180 can calculate a position of a wave generation source based on information sensed by an illumination sensor and a plurality of ultrasonic sensors. Since light is much faster than ultrasonic waves, a time for which the light reaches the optical sensor may be much shorter than a time for which the ultrasonic wave reaches the ultrasonic sensor. The position of the wave generation source may be calculated using the fact. In more detail, the position of the wave generation source may be calculated by using a time difference from the time that the ultrasonic wave reaches based on the light as a reference signal.

The camera 121 constructing the input unit 120 may be a type of camera sensor (for example, CCD, CMOS, etc.) The camera sensor may include at least one of a photo sensor and a laser sensor. The camera 121 and the laser sensor may be combined to detect a touch of the sensing object with respect to a 3D stereoscopic image. The photo sensor may be laminated on the display device. The photo sensor may be configured to scan a movement of the sensing object in proximity to the touch screen. In more detail, the photo sensor may include photo diodes and transistors at rows and columns to scan content placed on the photo sensor by using an electrical signal which changes according to the quantity of applied light. Namely, the photo sensor may calculate the coordinates of the sensing object according to variation of light to thus obtain position information of the sensing object.

The display unit 151 may output information processed in the mobile terminal 100. For example, the display unit 151 may display execution screen information of an application program driven in the mobile terminal 100 or user interface (UI) and graphic user interface (GUI) information in response to the execution screen information.

Furthermore, the display unit 151 may also be implemented as a stereoscopic display unit for displaying stereoscopic images. The stereoscopic display unit may employ a stereoscopic display scheme such as stereoscopic scheme (a glass scheme), an auto-stereoscopic scheme (glassless scheme), a projection scheme (holographic scheme), or the like.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may also provide audible output signals related to a particular function (e.g., a call signal reception sound, a message reception sound, etc.) performed by the mobile terminal 100. The audio output module 152 may include a receiver, a speaker, a buzzer or the like.

A haptic module 153 may generate various tactile effects the user can feel. A typical example of the tactile effect generated by the haptic module 153 may be vibration. Strength, pattern and the like of the vibration generated by the haptic module 153 may be controllable by a user selection or setting of the controller. For example, the haptic module 153 may output different vibrations in a combining manner or a sequential manner.

Besides vibration, the haptic module 153 may generate various other tactile effects, including an effect by stimulation such as a pin arrangement vertically moving with respect to a contact skin, a spray force or suction force of air through a jet orifice or a suction opening, a touch on the skin, a contact of an electrode, electrostatic force, etc., an effect by reproducing the sense of cold and warmth using an element that can absorb or generate heat, and the like.

The haptic module 153 may be implemented to allow the user to feel a tactile effect through a muscle sensation such as the user's fingers or arm, as well as transferring the tactile effect through a direct contact. Two or more haptic modules 153 may be provided according to the configuration of the mobile terminal 100.

An optical output module 154 may output a signal for indicating an event generation using light of a light source. Examples of events generated in the mobile terminal 100 may include a message reception, a call signal reception, a missed call, an alarm, a schedule notice, an email reception, an information reception through an application, and the like.

A signal output by the optical output module 154 may be implemented so the mobile terminal emits monochromatic light or light with a plurality of colors. The signal output may be terminated as the mobile terminal senses a user's event checking.

The interface unit 160 may serve as an interface with every external device connected with the mobile terminal 100. For example, the interface unit 160 may receive data transmitted from an external device, receive power to transfer to each element within the mobile terminal 100, or transmit internal data of the mobile terminal 100 to an external device. For example, the interface unit 160 may include wired or wireless headset ports, external power supply ports, wired or wireless data ports, memory card ports, ports for connecting a device having an identification module, audio input/output (I/O) ports, video I/O ports, earphone ports, or the like.

Further, the identification module may be a chip that stores a variety of information for authenticating authority of using the mobile terminal 100 and may include a user identity module (UIM), a subscriber identity module (SIM), a universal subscriber identity module (USIM), and the like. In addition, the device having the identification module (referred to as ‘identifying device’, hereinafter) may take the form of a smart card. Accordingly, the identifying device may be connected with the terminal 100 via the interface unit 160.

Furthermore, when the mobile terminal 100 is connected with an external cradle, the interface unit 160 may serve as a passage to allow power from the cradle to be supplied to the mobile terminal 100 therethrough or may serve as a passage to allow various command signals input by the user from the cradle to be transferred to the mobile terminal therethrough. Various command signals or power input from the cradle may operate as signals for recognizing that the mobile terminal is properly mounted on the cradle.

The memory 170 may store programs for operations of the controller 180 and temporarily store input/output data (for example, phonebook, messages, still images, videos, etc.). The memory 170 may store data related to various patterns of vibrations and audio which are output in response to touch inputs on the touch screen.

The memory 170 may include at least one type of storage medium including a Flash memory, a hard disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 170 over the Internet.

Further, as aforementioned, the controller 180 can typically control the general operations of the mobile terminal 100. For example, the controller 180 can set or release a locked state for restricting a user from inputting a control command with respect to applications when a status of the mobile terminal meets a preset condition.

Furthermore, the controller 180 can also perform controlling and processing associated with voice calls, data communications, video calls, and the like, or perform pattern recognition processing to recognize a handwriting input or a picture drawing input performed on the touch screen as characters or images, respectively. In addition, the controller 180 can control one or combination of those components in order to implement various exemplary embodiment disclosed herein on the mobile terminal 100.

The power supply unit 190 may receive external power or internal power and supply appropriate power required for operating respective elements and components included in the mobile terminal 100 under the control of the controller 180. The power supply unit 190 may include a battery. The battery may be an embedded battery which is rechargeable or be detachably coupled to the terminal body for charging.

Furthermore, the power supply unit 190 may include a connection port. The connection port may be configured as one example of the interface unit 160 to which an external (re)charger for supplying power to recharge the battery is electrically connected. As another example, the power supply unit 190 may be configured to recharge the battery in a wireless manner without use of the connection port. Here, the power supply unit 190 may receive power, transferred from an external wireless power transmitter, using at least one of an inductive coupling method which is based on magnetic induction or a magnetic resonance coupling method which is based on electromagnetic resonance.

Further, various embodiments described herein may be implemented in a computer-readable or its similar medium using, for example, software, hardware, or any combination thereof. A mobile terminal including at least one of the constituent elements may perform communication in a wireless manner. Hereinafter, a method of controlling an external device through communication in the mobile terminal will be described.

FIG. 1D is a conceptual view illustrating the environment of the internet of things according to an embodiment of the present disclosure. The Internet of Things (IOT) collectively refers to facilities in which things existing in a physical world and a virtual world are connected based on a communication technology to provide various services. The IOT provides services of sharing information between a thing and a thing through a network without any human intervention. Such things may be things in life, for example, a refrigerator, a TV set, a window, a washer, a gas range, and the like.

Technologies for implementing the IOT include a sensing technology for acquiring information from the surrounding environment of things, a wired and wireless communication and network infra technology for supporting communication between a thing and a thing, a serviced interface technology for providing various services.

The present disclosure provides a method of controlling the environment of the IOT using a mobile terminal. In particular, a mobile terminal according to an embodiment of the present disclosure can perform communication with things in a wireless manner. The foregoing communication includes a short-range communication mode such as a Bluetooth communication mode, a beacon communication mode, an NFC communication mode, and the like. Furthermore, the mobile terminal can perform communication with things through various communication modes other than the short-range communication mode.

Referring to FIG. 1D, the mobile terminal can perform communication with a refrigerator 200a, a laptop 200b, a speaker 200c, and a TV set 200d. In this instance, the mobile terminal can collect information from the refrigerator 200a, the laptop 200b, the speaker 200c, and the TV set 200d, and control the refrigerator 200a, the laptop 200b, the speaker 200c, and the TV set 200d using that information.

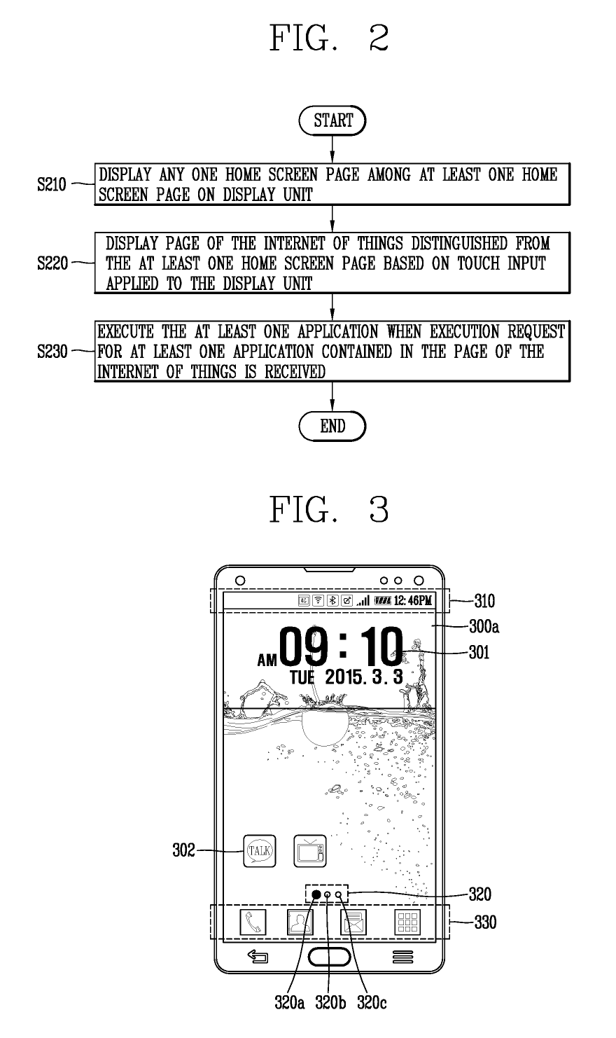

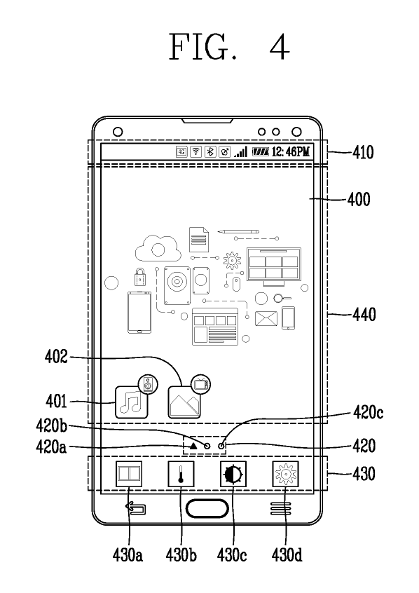

Hereinafter, a method for controlling the environment of the IOT in a mobile terminal according to an embodiment of the present disclosure will be described with reference to the accompanying drawings. In particular, FIG. 2 is a flow chart illustrating a method of providing a page of the IOT to control the environment of the IOT in a mobile terminal according to an embodiment of the present disclosure. FIG. 3 is a conceptual view illustrating a home screen page. FIG. 4 is a conceptual view illustrating a page of the IOT and a home screen page in a mobile terminal according to an embodiment of the present disclosure.

First, the mobile displays any one home screen page on a display unit (S210). Here, the home screen page includes screen information indicating an idle state of the mobile terminal. Further, the home screen page may include a background image and an icon or widget of at least one application among a plurality of applications installed on the mobile terminal.

Furthermore, the home screen page may include a plurality of regions. The plurality of regions may include different information. More specifically, as illustrated in FIG. 3, a home screen page may include a status display region 310 for displaying the status information indicating the status of a mobile terminal, an identification information region 320 for displaying the identification information of at least one home screen page, and a preset region 330 for displaying a default application.

Display information such as a remaining battery capacity of the mobile terminal, a current time, notification information on an event that has occurred on the mobile terminal, a communication status, and the like may be displayed in the status display region 310. The identification information of at least one home screen page may be displayed in the identification information region 320. For example, as illustrated in FIG. 3, the identification information may be a graphic object indicating at least one home screen page, respectively.

The controller 180 displays a graphic object indicating a home screen page currently displayed on the display unit 151 among graphic objects indicating the at least one home screen page, respectively, to be visually distinguished from the remaining graphic objects. For example, as illustrated in FIG. 3, the controller 180 displays a graphic object 320a indicating a home screen page currently displayed on the display unit 151 to be visually distinguished from the remaining graphic objects 320b, 320c. Thus, a user can know the location of a home screen page currently displayed on the display unit 151.

An icon of a default application can be displayed in the preset region 330. For example, the default application may include a call application, a message application, an internet application, and the like. The default application can also be changed by the user. Further, the home screen page may be substituted by terms such as a menu screen, an idle screen or the like.

When any one home screen page is displayed on the display unit, the mobile terminal displays a page of the IOT distinguished from the at least one home screen page based on a touch input applied to the display unit (S220). The controller 180 can display a page of the IOT based on a preset type of touch applied to the display unit when any one home screen page is displayed. For example, the controller 180 can display a page of the IOT instead of any one home screen page based on a drag input applied to the any one home screen page.

A page of the IOT as a page distinguished from at least one home screen page is a page for providing a function of controlling an external device through communication between the mobile terminal and an external device or executing an application installed on the mobile terminal in linkage with the external device. The external device includes at least one of an external device having a history that has communicated with a mobile terminal or capable of currently performing communication therewith, an external device connected to an application, an external device for which identification information is stored in a memory, and an external device set by a user. Here, the external device may be an electronic device having a communication module. For example, the external device may be a refrigerator, a washer, a boiler, a speaker, and the like provided with a communication module.

Considering a page of the IOT in more detail along with FIG. 4, a page of the IOT may include a status display region 410 for displaying the status information of a mobile terminal, an identification information region 420 for displaying the identification information of a page of the IOT, a preset region 430 basically set to a page of the IOT, and a page of the IOT 440. A portion similar to the foregoing home screen page will be substituted by the description of a home screen page, and hereinafter, it will be described around a difference between a page of the IOT and a home screen page.

A graphic object 420a indicating the identification information of a page of the IOT and a graphic object 420b, 420c indicating the identification information of a home screen page may be displayed in the identification information region 420. Further, the icons of applications basically set on a page of the IOT may be displayed in the preset region 430. For example, an icon 430a of an application for controlling the opening or closing of a window, an icon 430b of an app for controlling a boiler temperature, an icon 430c of an application for controlling an indoor temperature, and an environment setting icon 430d of a page of the IOT may be displayed. The icon of a default application can be changed by a user.

An icon 401, 402 of at least one application connected to an external device among a plurality of applications installed on a mobile terminal can be also displayed on a page of the IOT in the page of the IOT 440. For example, referring to FIG. 4, the page of the IOT 440 may include an icon 401 of a music application connected to a speaker, an icon of a photo application 402 connected to TV, and the like.

Applications contained in a page of the IOT can be set by a user or previously set. Furthermore, applications contained in a page of the IOT can be added or deleted by a user's control command. In addition, a badge associated with a specific external device can be additionally displayed on the icons of applications contained in the page of the IOT. In other words, a badge associated with an external device connected to each application can be further displayed on the icons of application contained in the page of the IOT.

When an execution request for at least one application contained in a page of the IOT is received when the page of the IOT is displayed on the display unit, the mobile terminal transmits information associated with the at least one application to execute the at least one application on a specific external device (S230).

Further, the controller 180 can receive an execution request for any application among at least one application contained in a page of the IOT. The execution request may be received by a touch input, a gesture input, a button input or the like. For example, a user can apply a touch input to an icon of any application among the icons of at least one application to enter an execution request for any application.

When an execution request for any application is received, the controller 180 can transmit information associated with any application to a specific external device through communication. The specific external device can execute any application based on information associated with any application.

Alternatively, when an execution request for any application is received, the controller 180 can execute any application on the mobile terminal. Furthermore, the controller 180 can transmit information associated with the execution of the any application to a specific external device. In this instance, the specific external device outputs information associated with any application in at least one of visual, auditory and tactile modes.

For example, when an execution request for a music application is received, the controller 180 can transmit information associated with a music application to a speaker to play music through a speaker connected to the music application. In this instance, the speaker can output music in an auditory manner based on information associated with the music application.

In another example, the controller 180 can execute a music application on a mobile terminal, and then transmit information corresponding to music currently being played to a speaker. In this instance, the speaker can output music based on information corresponding to the music without directly executing the music application.

Further, the controller 180 can sense a communication state with a specific external device in real time when any application is being executed on a specific external device. The communication state may be either one state between a communication enabled state or communication disabled state to the specific external device.

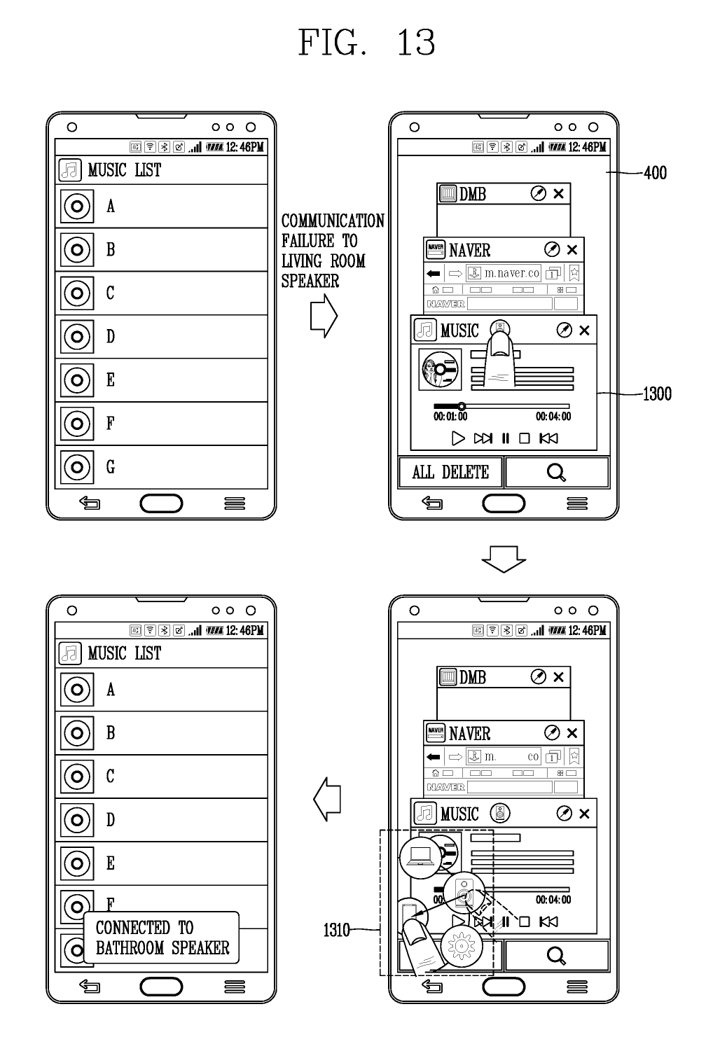

If a communication disabled state to a specific external device is sensed, the controller 180 can suspend the execution of any application. In this instance, the controller 180 can resume any application on a mobile terminal or resume any application on another external device. A control associated therewith will be described in FIG. 13.

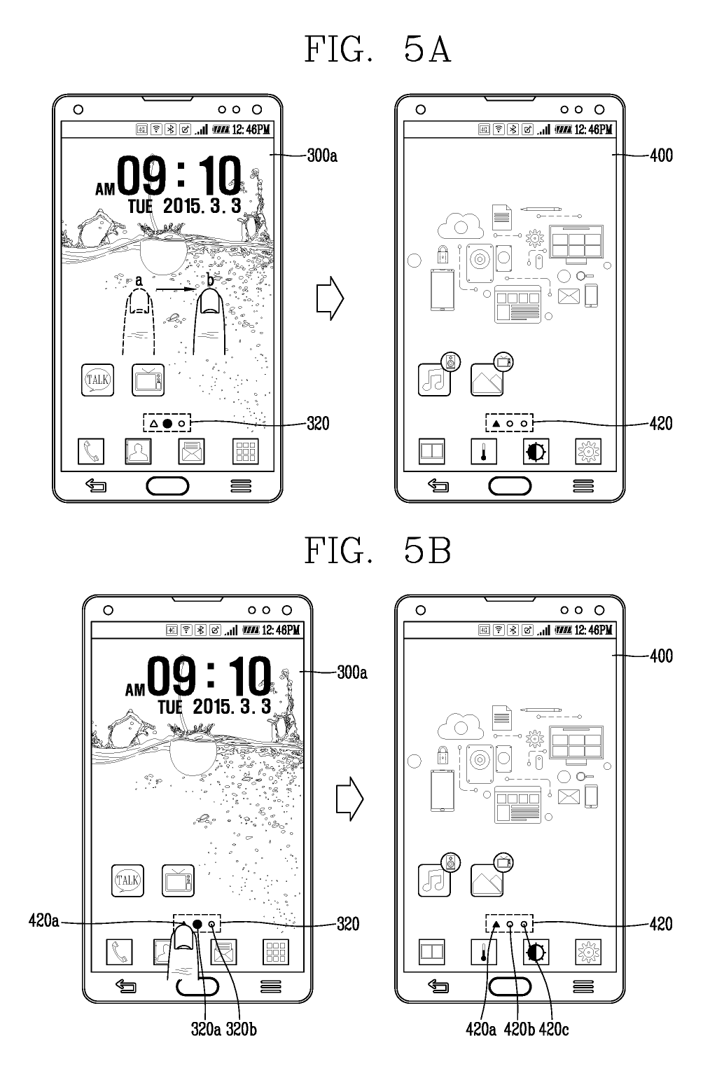

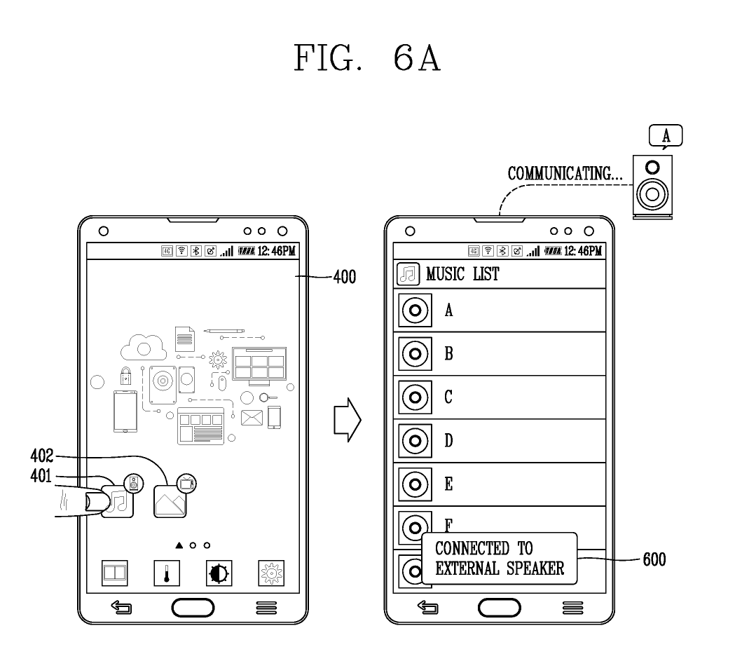

In the above, a method of controlling the environment of the IOT though a page of the IOT has been described. Hereinafter, a method of entering the foregoing page of the IOT will be described with reference to the drawings. In particular, FIGS. 5A and 5B are conceptual views illustrating a method of entering a page of the IOT.

The controller 180 of a mobile terminal according to an embodiment of the present disclosure can display any one home screen page among a plurality of home screen pages or a page of the IOT on the display unit 151 when the mobile terminal is in a standby state or the power of the mobile terminal is turned on.

In particular, when any one home screen page is displayed on the display unit 151, the controller 180 can display a page of the IOT in response to a user's control command (user's request, user's selection). For example, as illustrated in the first drawing of FIG. 5A, the controller 180 can sense a drag input applied to any one home screen page 300a in a preset direction (a direction from “a” to “b”). Further, as illustrated in the second drawing of FIG. 5A, the controller 180 can display a page of the IOT 400 on the display unit 151 in response to the drag input applied thereto.

In another example, as illustrated in the first drawing of FIG. 5B, the controller 180 can sense a touch applied to a graphic object 420a indicating the identification information of a page of the IOT when any one home screen page 300a is displayed. In this instance, as illustrated in the second drawing of FIG. 5B, the controller 180 can display a page of the IOT 400 in response to a touch applied to the graphic object 420a indicating the identification information of a page of the IOT.

In addition, the controller 180 can display a page of the IOT based on location information. More specifically, when the location of the mobile terminal corresponds to a preset location, the controller 180 can display a page of the IOT on the display unit 151. For example, when the location of the mobile terminal is home, the controller 180 can display a page of the IOT.

Here, the location of the mobile terminal can be detected through a beacon signal, GPS information or the like. In the above, a method of entering a page of the IOT has been described. The present disclosure can easily access a page of the IOT on an existing home screen page, thereby enhancing the user's convenience.

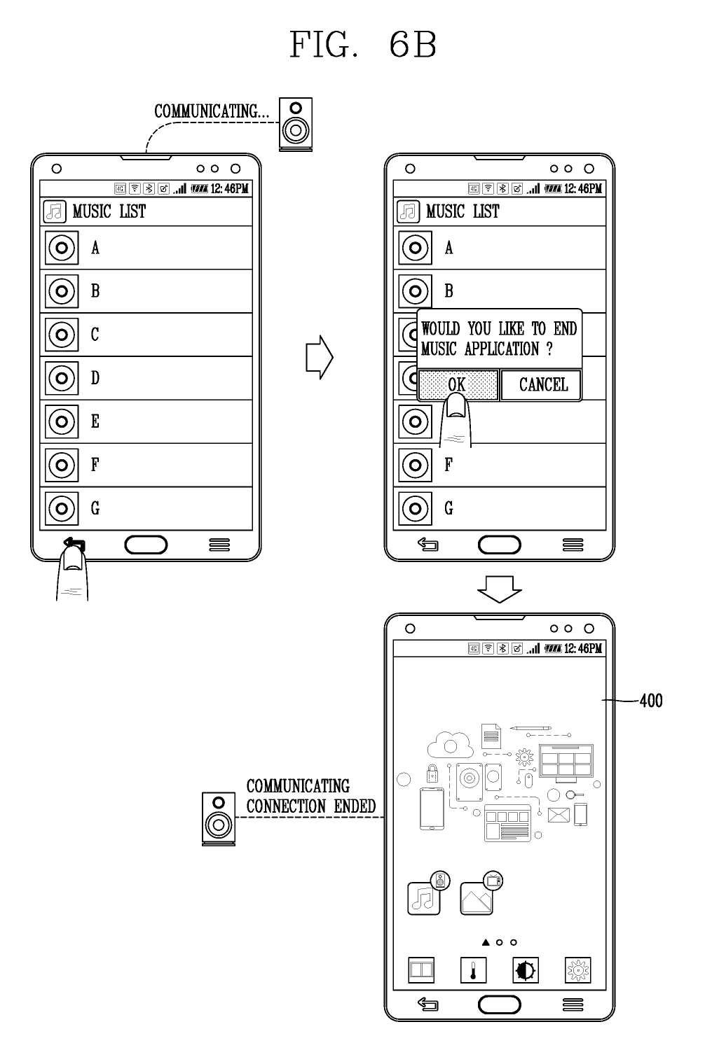

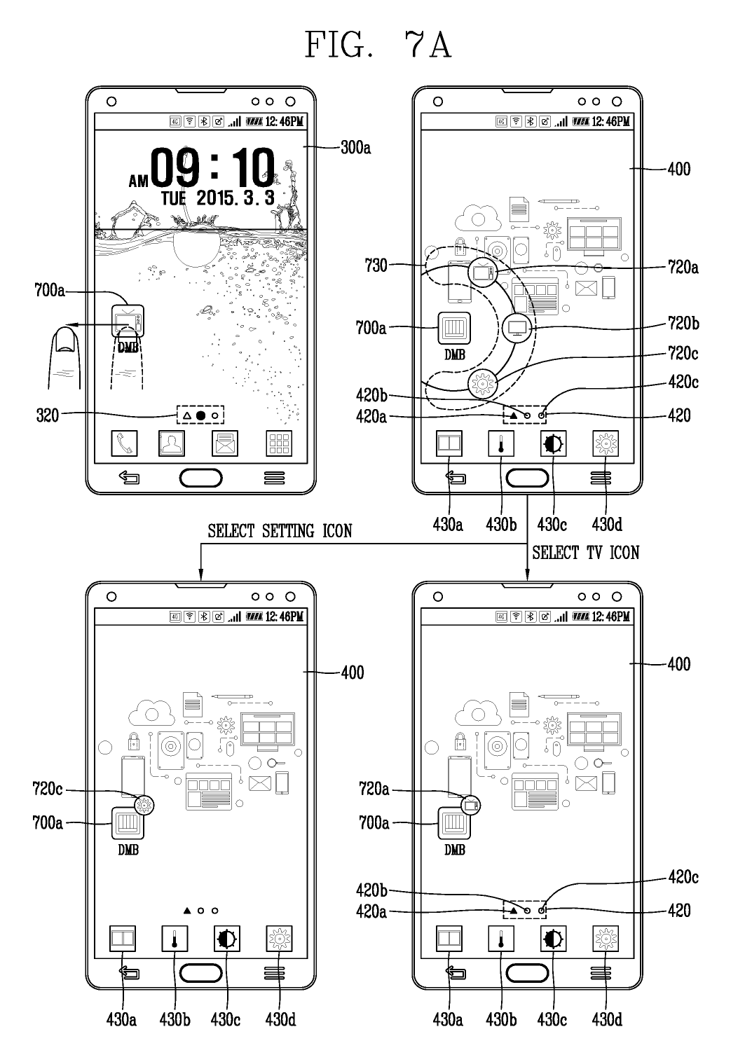

Hereinafter, a method of executing an application on a page of the IOT will be described. In particular, FIGS. 6A and 6B are conceptual views illustrating a method of executing an application on a page of the IOT. The controller 180 can execute any application among at least one application contained in a page of the IOT in response to a user's control command. The user's control command may be entered in various ways. For example, the user's control command may be entered by a touch, a gesture, a voice or the like.

For example, as illustrated in the first drawing of FIG. 6A, the controller 180 can receive an execution request for a music application in response to a touch applied to an icon 401 of the music application connected to a speaker contained in the page of the IOT 400.

When an execution request for the application is received, the controller 180 can execute the application in connection with a specific external device. More specifically, when an execution request for the application is received, the controller 180 can detect a specific external device connected to the application. When the specific external device is detected, the controller 180 can perform communication with the specific external device.

In this instance, the controller 180 can display notification information indicating the execution of communication with the specific external device on the display unit 151. For example, as illustrated in the second drawing of FIG. 6A, the controller 180 can display notification information such as “connected to external speaker” in a popup window 600 format on the display unit 151.

When performing communication with the specific external device, the controller 180 can transmit information associated with the application to the specific external device. When information associated with the application is received, the specific external device can execute the application based on information associated with the application. For example, as illustrated in the second drawing of FIG. 6A, the controller 180 can transmit music information such as “A” to a speaker connected to a music application through communication. In this instance, music information such as “A” can be output on the speaker.

On the contrary, the controller 180 can receive information associated with the application through the specific external device. In this instance, the controller 180 can execute the application based on information received from the specific external device. For example, when a music application is connected to a laptop, the controller 180 can receive music information stored in the laptop. In this instance, the controller 180 can display the received music information.

In other words, the controller 180 can transmit and receive information through communication with a specific external device to execute an application by connecting it to the specific external device. Further, the controller 180 can end the execution of the application based on the reception of a user's control command for ending the execution of the any application when the application is being executed.

More specifically, when a user's control command for ending the execution of application is received, the controller 180 can end the execution of the application. At the same time, the controller 180 can end communication with a specific external device to no longer perform communication with the specific external device that performs communication with the application. Accordingly, the specific external device can no longer transmit information associated with the application or transmit information associated with the application to the mobile terminal.

For example, as illustrated in the first and the second drawing of FIG. 6B, when a user's control command for ending the execution of any application is received, the controller 180 can end the execution of the application. As illustrated in the third drawing of FIG. 6B, when the execution of the application is ended, the controller 180 can display a page of the IOT 400 instead of an execution screen of the application. Furthermore, the controller 180 can end communication with a specific external device connected to any application.

In the above, a method of executing an application contained in a page of the IOT has been described. Thus, it is possible to easily connect a mobile terminal to a specific device for the execution thereof using a page of the IOT without passing through a complicated procedure.

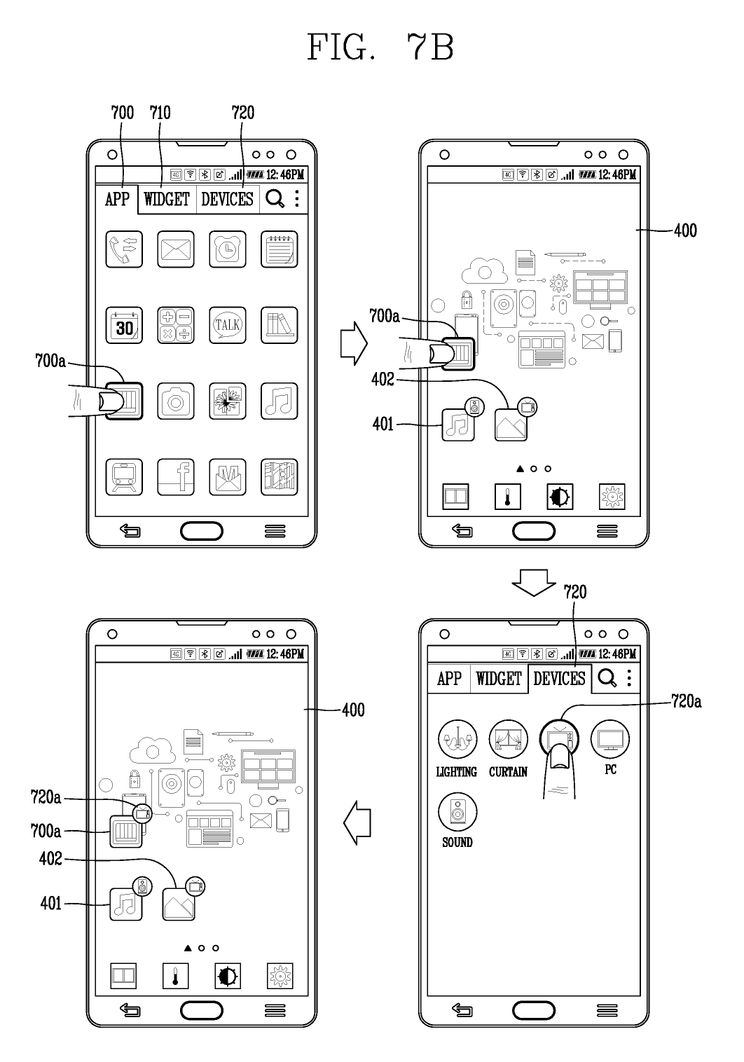

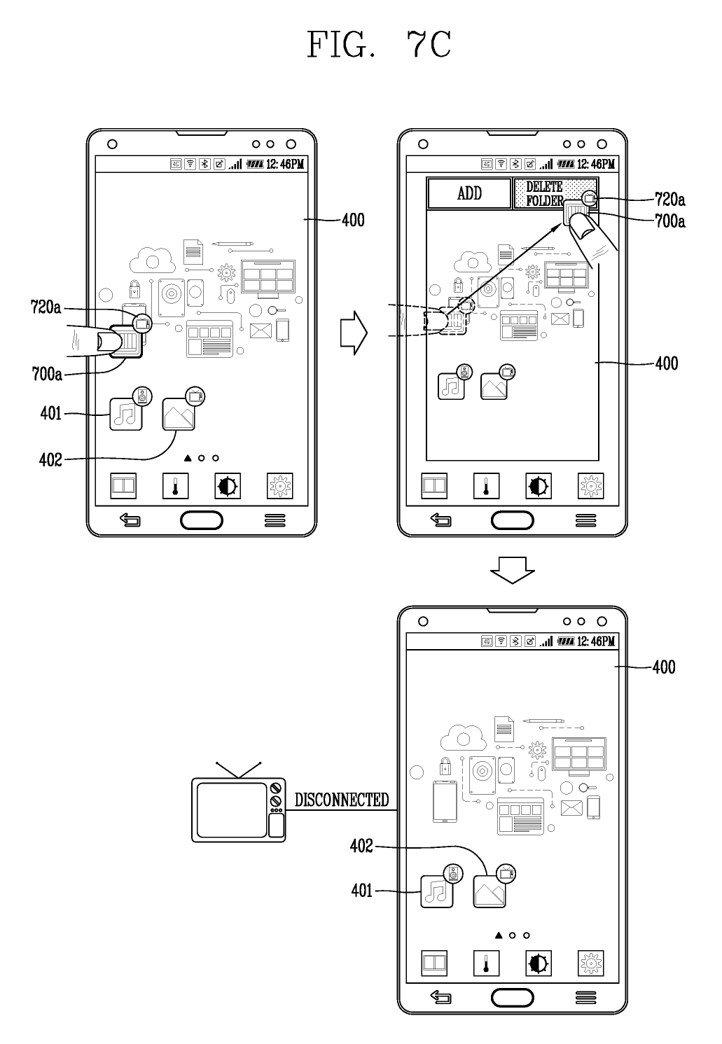

Hereinafter, a method of adding or deleting an application contained in a page of the IOT will be described. In particular, FIGS. 7A through 7C are conceptual views illustrating a method of adding or deleting an application contained in a page of the IOT.

The controller 180 can add or delete an application contained in a page of the IOT based on a user's control command. Adding an application to a page of the IOT denotes an operation of a mobile terminal for connecting the added application to a specific external device while displaying an icon of the application on the page of the IOT.

Furthermore, deleting an application from a page of the IOT denotes an operation of a mobile terminal for releasing a connection to an external device connected to the deleted application while no longer displaying an icon of the application on the page of the IOT. Here, releasing a connection to an external device denotes controlling a mobile terminal to no longer perform communication with the external device during the execution of an application.

In order to add an application to a page of the IOT, the user can select an application to be added to the page of the IOT. More specifically, the user can select at least one of applications contained in a home screen page or applications contained in a menu screen on the home screen page or menu screen as an application to be added to a page of the IOT. Then, the controller 180 can add an application selected by the user to the page of the IOT.

Hereinafter, a method of adding an application contained in a home screen page to a page of the IOT and a method of adding an application contained in a menu screen to a page of the IOT will be sequentially described. First, a method of adding an application contained in a home screen page to a page of the IOT will be described with reference to FIG. 7A.

When any home screen page 300a among a plurality of home screen pages previously set to a mobile terminal is displayed on the display unit 151, the controller 180 can sense a preset type of touch input applied to an icon of any application contained in the home screen page 300a. The preset type of touch input includes various touch modes such as a long touch or the like.

In this instance, the controller 180 can set any application to which the touch input is applied to an application that can be moved to another home screen page. Further, the controller 180 can move an icon of the application based on a consecutive drag input having a preset type of touch applied to an icon of the application. The controller 180 can move the icon of the application to a specific page among a plurality of home screen pages or pages of the IOT according to the direction of the drag input.

If a drag input to the icon of the application is released from a page of the IOT, then the controller 180 can add the icon of the application to the page of the IOT. For example, referring to the first and the second drawing of FIG. 7A, when a drag input to the icon 700a of a DMB application is released from the home screen 300a, the controller 180 can add a DMB application to the page of the IOT 400.

When any application contained in a home screen page is added to the page of the IOT 400, the controller 180 can display a list of external devices that are communicable with the application on the display unit 151. For example, as illustrated in the second drawing of FIG. 7A, when a DMB application is added to a page of the IOT 400, the controller 180 can display an external device list 730 including the icons 720a, 720b, 720c of external devices that are communicable with the DMB application on the page of the IOT 400.

The user can select an icon of an external device contained in the external device list to select an external device to be connected to the DMB application. For example, as illustrated in the third drawing of FIG. 7A, the controller 180 can control the DMB application so the DMB application is communicable with TV in response to a touch input applied to the TV icon 720a.

Further, the user can select the setting icon 720c to select other external devices that are not contained in the external device list. For example, as illustrated in the fourth drawing of FIG. 7A, when the setting icon 720c is selected, the controller 180 can display all the icons of external devices. Thus, the user can connect his or her desired external device to an application.

When the application is connected to a specific external device, the controller 180 can display a badge indicating a specific external device on a region adjacent to an icon of the application on a page of the IOT. For example, as illustrated in the third drawing of FIG. 7A, a badge 720a indicating TV can be displayed on a region adjacent to the icon 700a of a DMB application In other words, when an application is connected to an external device, the present disclosure can display two icons as one icon.

Next, a method of adding an application contained in a menu screen to a page of the IOT will be described with reference to FIG. 7B. First, the controller 180 can enter a menu screen based on a user's request. The menu screen may include an app screen 700 for displaying a plurality of icons corresponding to a plurality of applications, respectively, installed on a mobile terminal, a widget screen 710 for displaying a plurality of widgets corresponding to the plurality of portion applications, respectively, and a device screen 720 for displaying icons corresponding to external devices, respectively.

The app screen 700 may include an icon of an application stored in the memory 170 or an icon of an application for which URL information is stored in the memory 170. The widget screen 710 may include a widget of an application stored in the memory 170 or a widget of an application for which URL information is stored in the memory 170. The device screen 720 may include at least one of the icons of external devices for which identification information is stored in the memory, the icons of external devices that are currently communicable with a mobile terminal, and the icons of external devices for which a communication connection history with a mobile terminal is stored.

Further, the controller 180 can display icons that is connectable to the application expected to be added to a current page of the IOT 400 to be visually distinguished from the remaining icons contained in the device screen 720 For example, when an application expected to be added to a current page of the IOT 400 is determined as a DMB application, the controller 180 can change the color of icons of a TV set, a monitor that is connectable to the DMB application among the icons of a plurality of external devices contained in the device screen 720 to green.

A user can select an icon of any application to be added to a page of the IOT on the app screen 700. When the application is selected, the controller 180 can add the selected application to a page of the IOT. For example, as illustrated in the first and the second drawing of FIG. 7B, the controller 180 can display a DMB application on the page of the IOT 400 in response to a long touch applied to the icon 700a of the DMB application.

When any application is added to a page of the IOT, the controller 180 can determine whether or not there exists a specific external device connected to any application. If there exists a specific external device, the controller 180 can control any application to be connected and executed to a specific external device during the execution of the application.

If there does not exist a specific external device, the controller 180 can display screen information for selecting a specific external device to be connected and executed during the execution of the application based on a user's request or in an automatic manner. For example, as illustrated in the third drawing of FIG. 7B, the controller 180 can display the device screen 720 that displays icons corresponding to external devices, respectively.

The controller 180 can select a specific external device to be connected and executed to the application in response to a preset type of touch applied to the specific external device among external devices. For example, the controller 180 can sense a long touch applied to the icon 720a corresponding to TV among icons corresponding to external devices, respectively. In this instance, the controller 180 can set the icon 720a to a state that is connectable to an application, and control the display unit 151 to display the icon 720a corresponding to TV on a page of the IOT 400.

Then, the controller 180 can move the icon 720a corresponding to TV on the display unit 151 according to a drag input consecutively applied to the long touch. The controller 180 can control the DMB application to be connected and executed to TV in response to the drag input being released when the icon 702a corresponding to TV is located on a region displayed with the icon 700a of the DMB application.

When the application is connected to a specific external device, the controller 180 can display a badge indicating a specific external device on a region adjacent to an icon of the application on a page of the IOT. For example, as illustrated in the fourth drawing of FIG. 7B, a badge 720a indicating TV may be displayed on a region adjacent to the icon 700a of the DMB application.

Further, considering a method of deleting an application in more detail with reference to 7C, when a user's control command for deleting any application among at least one application contained in a page of the IOT is applied to the page of the IOT, the controller 180 can no longer display the application on a page of the IOT.

For example, as illustrated in FIG. 7C, the controller 180 can allow the icon 700a of any application to disappear from a page of the IOT. At the same time, the controller 180 can release a connection between the application and the specific external device such that the application is not connected and executed to a specific external device connected to the application.

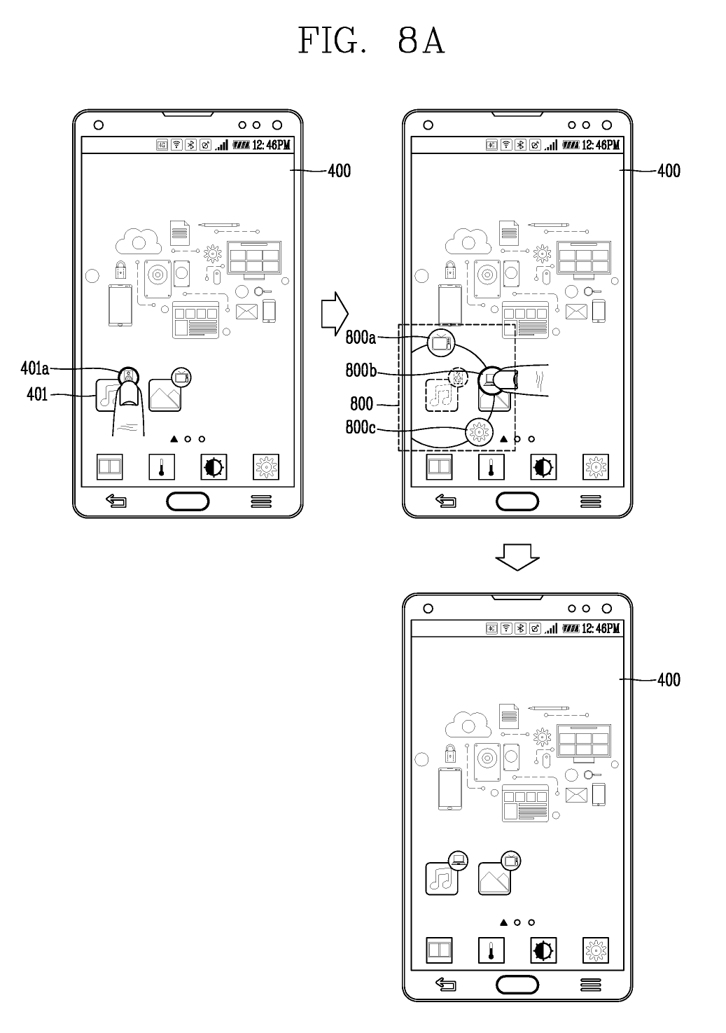

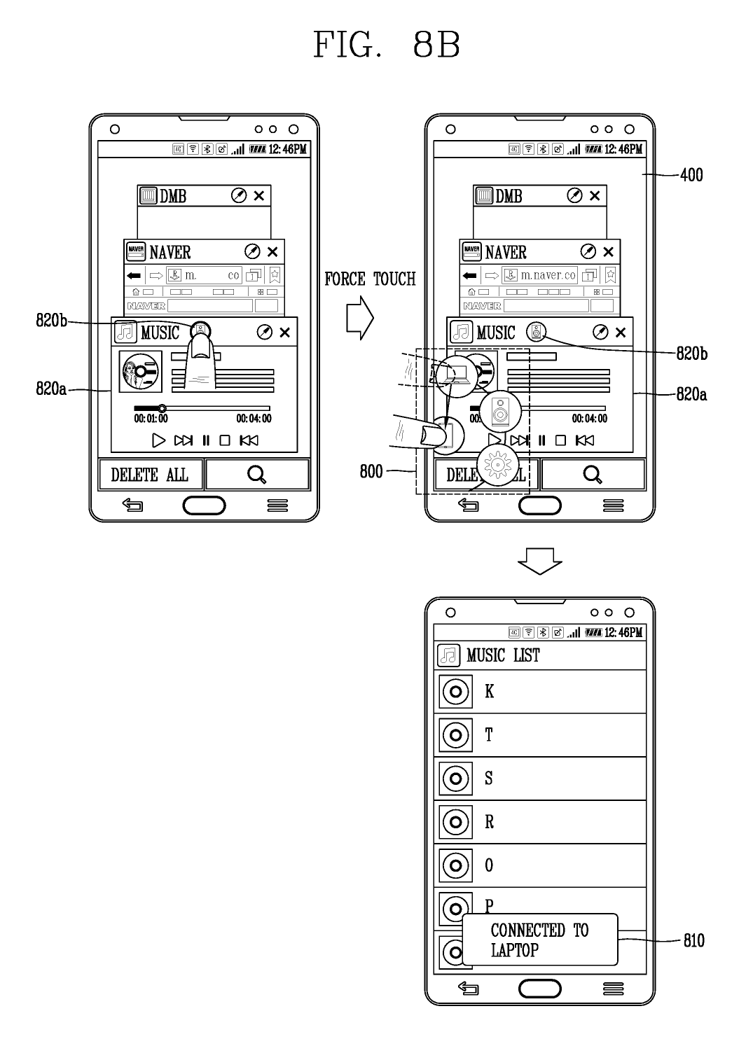

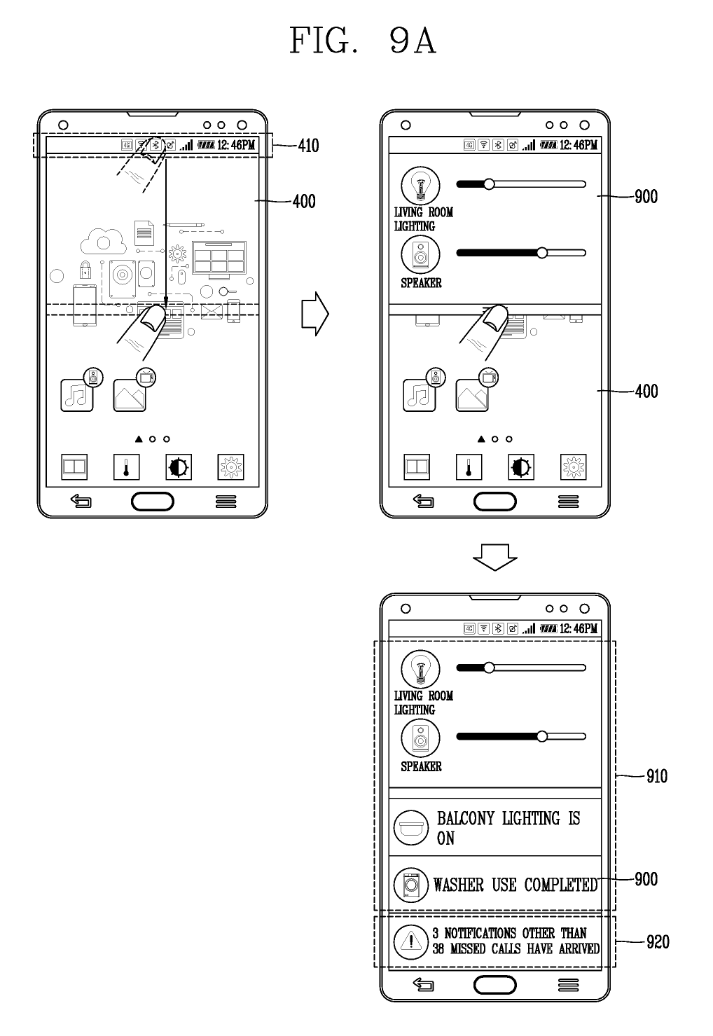

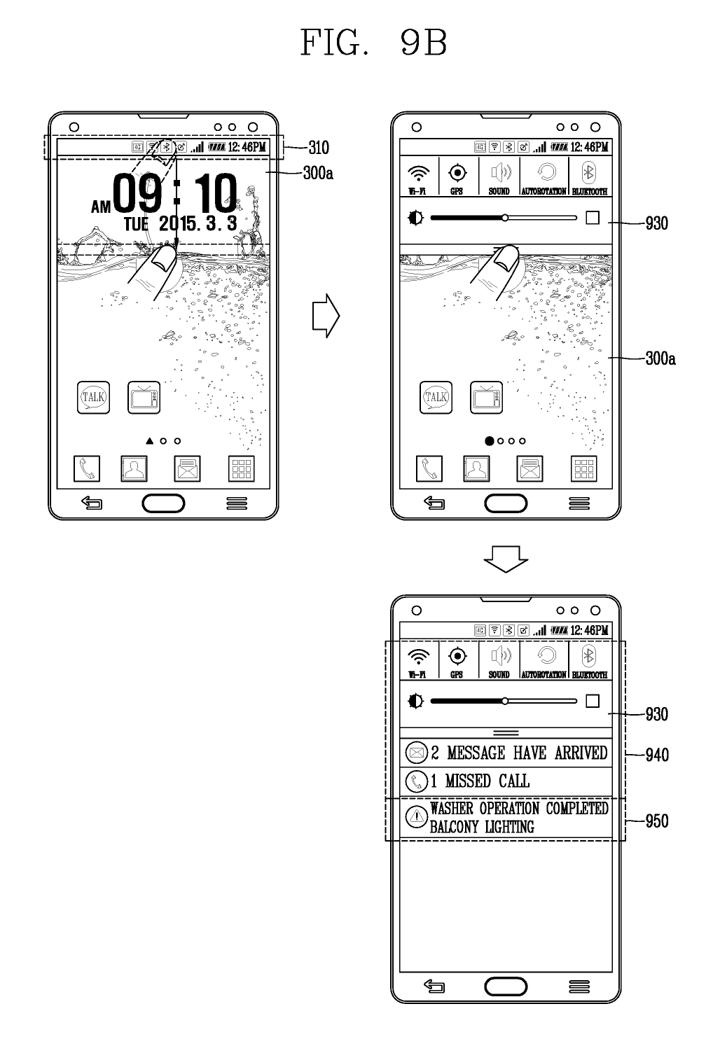

In the above, a method of adding or deleting an application on a page of the IOT has been described. Hereinafter, a method of changing an external device connected to an application contained in a page of the IOT will be described. FIGS. 8A and 8B are conceptual views illustrating a method of changing an external device connected to an application contained in a page of the IOT.

The controller 180 can change an external device connected to each application to another device based on a user's request for device change to an external device connected to at least one application, respectively, contained in a page of the IOT. For example, as illustrated in the first drawing of FIG. 8A, the controller 180 can sense a touch input applied to a badge 401a displayed adjacent to an icon 401 of a music application connected to a speaker among applications contained in a page of the IOT.

The controller 180 can display an external device list including at least one external device on the display unit 151 in response to the reception of a user's request for device change. The external device list may include at least one of an external device that is connectable to the application, an external device for which identification information is stored in a mobile terminal, and an external device that is communicable with a mobile terminal. For example, as illustrated in the second drawing of FIG. 8A, the controller 180 can display an external device list 800.

Further, a user can select any external device to be connected to an application among at least one external device displayed on the external device list 800. For example, as illustrated in the second drawing of FIG. 8A, the controller 180 can select a laptop 800b between a TV set 800a and the laptop 800b contained in the external device list 800.

When any external device is selected, the controller 180 can change an external device previously connected to the application to the selected external device to be connected thereto. In other words, the controller 180 can release a connection to the external device previously connected to the application, and connect the selected external device to the application. For example, as illustrated in the third drawing of FIG. 8A, the controller 180 can connect a laptop to a music application.

When an external device connected to an application is changed, the controller 180 can allow the application to be connected and executed to the changed external device during the execution of the application. Further, when any application is connected and executed to an external device connected to the application, the controller 180 can change the external device connected thereto based on a user's control command. In this instance, the controller 180 can continuously execute the application through communication with the changed external device.

More specifically, a user can change an external device connected to an application currently being executed using an app list of applications that are currently being executed or have been recently executed. Thus, when any application is being connected and executed to a specific external device, the user can apply a control command for displaying an app list of applications that are currently being executed or have been recently executed to change the external device. In this instance, as illustrated in the first drawing of FIG. 8B, the controller 180 can display an app list on the display unit.

The app list may include an image indicating an application that is currently being executed or has been recently executed. Here, the application that is currently being executed or has been recently executed denotes an application being executed on a background or foreground of the mobile terminal. Furthermore, in case of an application with an external device connected to the application among the images, an external device image may be displayed on the image.

The controller 180 can display an external device list for changing an external device connected to the application in response to a long touch applied to an image indicating the application. For example, as illustrated in the first drawing of FIG. 8B, the controller 180 can display the external device list 800 in response to a long touch applied to the image 820aindicating a music application.

The user can change an external device connected to an application using external devices contained in the external device list 800. For example, as illustrated in the second and the third drawing of FIG. 8B, the controller 180 can change an external device connected to the music application from a speaker to a laptop.

When the external device is changed, the controller 180 can execute a function being executed on an application prior to changing the external device as it is on the changed external device. For example, the controller 180 can release a connection between a mobile terminal and a speaker while music “A” is output through the speaker, and continuously output the music “A” from a laptop when the laptop is connected thereto. Accordingly, the user can maintain the continuity of the execution of an application even though an external device connected thereto is changed during the execution of a specific application.

Furthermore, the controller 180 can determine a transmission subject of information based on the direction of a drag input to graphic objects indicating external devices contained in the external device list. More specifically, the controller 180 can set a mobile terminal to a transmission subject of information, and transmit information associated with an application from the mobile terminal to an external device based on a drag input in a first direction applied to a graphic object indicating a specific external device.

On the contrary, the controller 180 can set a specific external device to a transmission subject of information, and receive information at the mobile terminal from the specific external device based on a drag input in a second direction different from the first direction applied to a graphic object indicating a specific external device.

In other words, the controller 180 can determine a transmission subject for transmitting information based on the direction of a drag input. For example, as illustrated in the second drawing of FIG. 8B, the controller 180 can control a laptop to transmit information associated with a music application to a mobile terminal from the laptop based on a drag input in a first direction applied to a graphic object indicating the laptop. In this instance, a music application can be executed on the mobile terminal based on the information of an application associated with music received from the laptop.

In the above, a method of changing an external device connected to an application contained in a page of the IOT has been described. Hereinafter, the characteristics of a notification window displayed on a page of the IOT and a home screen page will be described. In particular, FIGS. 9A and 9B are conceptual views illustrating the characteristics of a notification window displayed on a page of the IOT and a home screen page.

The controller 180 can display a notification window in response to a preset type of touch applied to the status display region 310, 410 contained in a home screen page or page of the IOT. For example, as illustrated in the first drawing of FIG. 9A, the controller 180 can display a notification window in the status display region 410 of a page of the IOT in response to a drag input in an up-down direction of the display unit.

The notification window may display an icon for changing the environment setting of a mobile terminal or notification information for notifying the event occurrence of an application installed on a mobile terminal. For example, the notification window may include notification information for notifying that a message has been received on a message application, an icon for setting the communication status of Wi-Fi and the like.

Further, the present disclosure provides a notification window displayed on a home screen page or a notification window displayed on a page of the IOT in different display formats. More specifically, as illustrated in FIG. 9A, when a notification window 900 is displayed in response to a drag input applied to the status display region 410 of a page of the IOT, the notification window 900 can include a first region 910 for displaying notification information associated with a page of the IOT and a second region 920 for displaying notification information associated with a home screen page.

The first region 910 can display notification information associated with a page of the IOT in a detailed view format. On the contrary, the second region 920 can display a plurality of notification information associated with home screen page in a brief view format. Accordingly, the first region can occupy a larger area than that of the second region.

On the contrary, as illustrated in FIG. 9B, when a notification window 930 is displayed in response to a drag input applied to the status display region 310 of any home screen page 300a, the notification window 900 can include a third region 940 for displaying notification information associated with the home screen page and a fourth region 950 for displaying notification information associated with a page of the IOT.

The third region 940 can display notification information associated with a home screen page in a detailed view format. On the contrary, the fourth region 950 can display notification information associated with a page of the IOT in a brief view format. Accordingly, the third region can occupy a larger area than that of the second region.

In addition, the controller 180 can provide notification information associated with an event that has occurred on a page of the IOT or home screen page to a user using a graphic object indicating the identification information of the page of the IOT or home screen page.

More specifically, when an event that has occurred on an application contained in a specific home screen page is sensed when a page of the IOT is displayed on the display unit, the controller 180 can display a graphic object indicating the identification information of the specific home screen page to have an animation effect.

Here, the animation effect may be an effect of blinking a graphic object, an effect of changing the shape of a graphic object, an effect of changing the color of a graphic object, and the like. Similarly, when an event that has occurred on an application contained in a page of the IOT is sensed when a specific home screen page is displayed on the display unit, the controller 180 can display a graphic object indicating the identification information of the page of the IOT to have an animation effect.

Accordingly, a user can recognize an event associated with a page of the IOT or home screen page that is not currently displayed on the display unit. Thus, a user can provide notification information to be provided to the user on a page of the IOT of home screen page in a proper format. Furthermore, the notification information of another page may be also checked in brief even on a page of the IOT or home screen page.

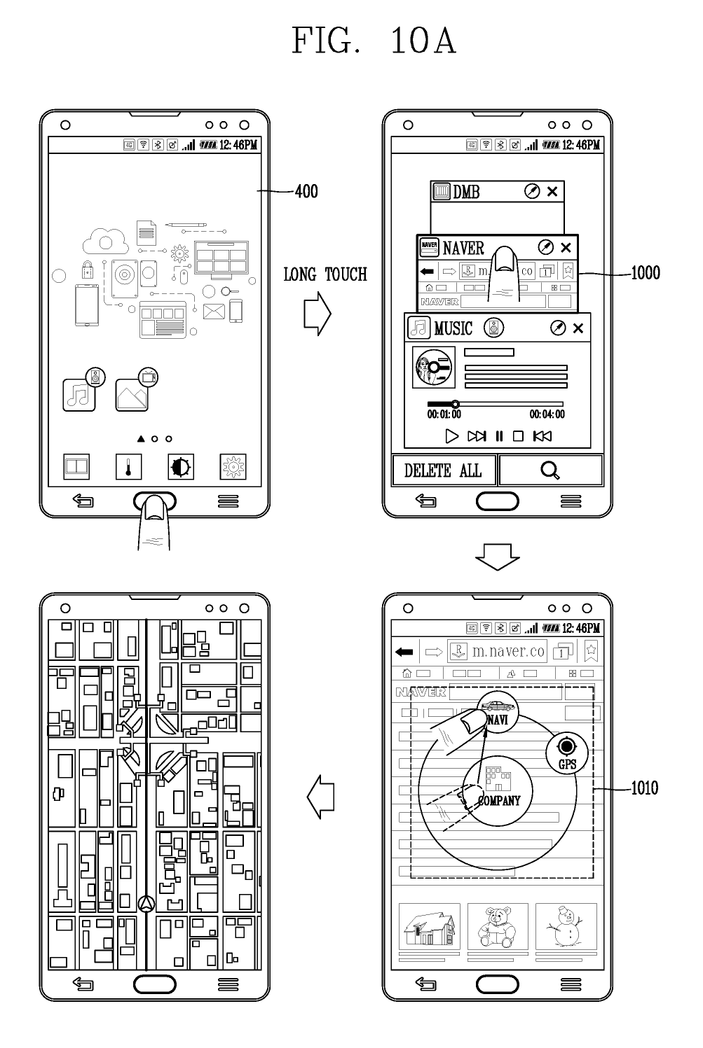

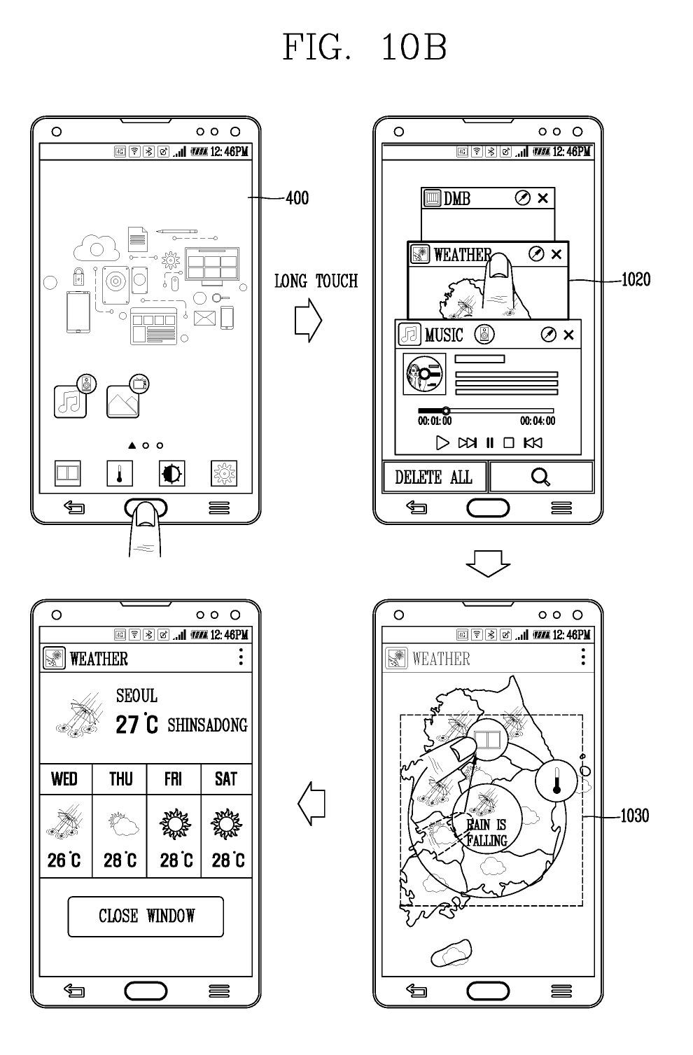

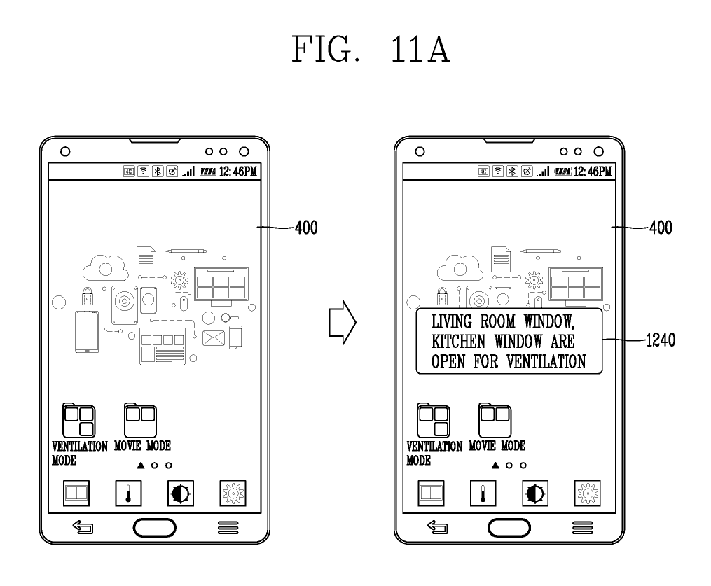

Hereinafter, a method of allowing an application being executed in a mobile terminal without being connected to an external device to be connected and executed to the external device will be described. In particular, FIGS. 10A and 10B are conceptual views illustrating a method of allowing an application being executed in a mobile terminal without being connected to an external device to be connected and executed to the external device.

When any application is performed on a home screen page other than a page of the IOT, the controller 180 can execute the application without being connected to an external device. For example, when a music application is performed on a home screen page other than a page of the IOT, the controller 180 can execute the music application without being connected to a speaker.

The controller 180 can control the application to be connected and executed to an external device based on a user's control command when the application is being performed without being connected to the external device. Thus, a user can use an app list that is currently being executed or have been recently executed.

More specifically, the user can apply a control command for displaying the app list when a page of the IOT is displayed on the display unit 151. In this instance, as illustrated in the second drawing of FIG. 10A, an app list may be displayed. Further, the controller 180 can display an external device list that can be connected and executed to any application based on a touch input applied to an image indicating the application being executed without being connected to an external device among images contained in the app list.

For example, as illustrated in the second and third drawing of FIG. 10A, the controller 180 can display an external device list 1010 in response to a touch input applied to an image 1000 indicating an internet application being executed without being connected to an external device. Further, the controller 180 can determine an external device to be contained in an external device list based on the execution status information of the application. In other words, external devices displayed on the external device list can be determined based on the execution status information of an application.

For example, as illustrated in the third drawing of FIG. 10A, when the execution status information of an internet application includes specific place information, the external device list may include external devices associated with location information such as a navigation or GPS sensor. In another example, when the execution status information of an internet application includes specific weather information, the external device list may include a window switching device, a boiler, and the like.

When a specific external device is selected from the external device list, the controller 180 can allow the application to be connected and executed to the external device. For example, as illustrated in the fourth drawing of FIG. 10A, when navigation is selected, the controller 180 can allow an internet application to be connected and executed. In this instance, road guide information associated with a specific place received from the internet application may be displayed on the display unit 151.

In still another example, as illustrated in FIG. 10B, an external device list of external devices capable of using weather information may be displayed in response to a touch input applied to an image 1020 indicating a weather application. In this instance, external devices capable of using weather information may include a window switching device, a boiler, and the like.

Further, when the window switching device is selected, the controller 180 can control a window to be closed when the weather information is cloudy, and control the window to be open when the weather information is clear. Accordingly, when an application being executed without being connected to an external device is connected to the external device, the present disclosure may control the external device in a suitable manner to the execution status of the application, thereby enhancing the user's convenience.

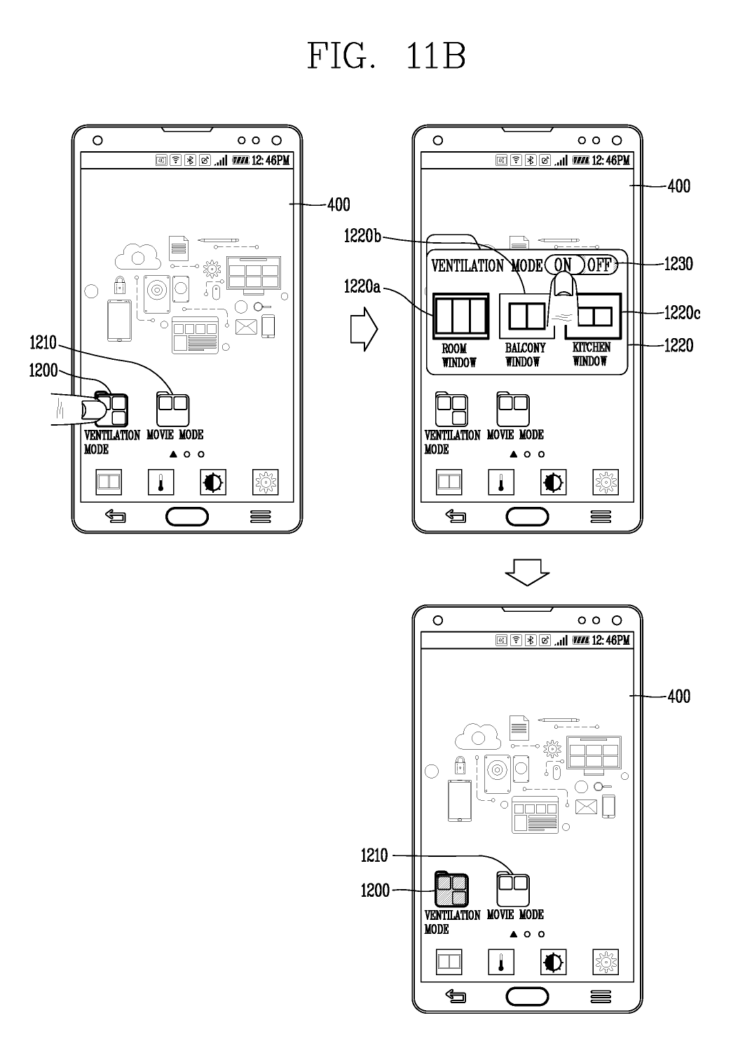

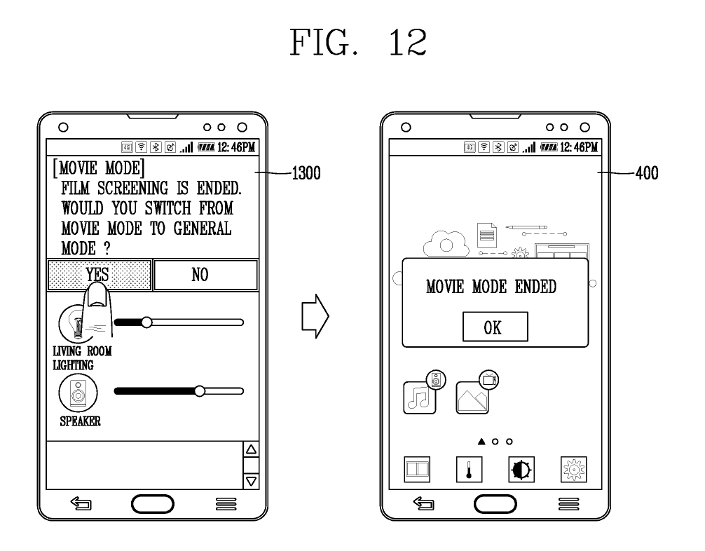

Hereinafter, a feature associated with a folder image contained in a page of the IOT will be described. In particular, FIGS. 11A through 12 are conceptual views illustrating a feature associated with a folder image contained in a page of the IOT. The present disclosure provides a mode function capable of executing functions associated therewith at once through a page of the IOT. The mode function denotes a function set to concurrently execute a plurality of functions through a one-time control command. Furthermore, the mode function denotes a function set to concurrently execute a plurality of functions to have a preset setting value through one time control command.

For example, a ventilation mode is a mode in which a living room window, a balcony window and a kitchen window are switched at the same time, and a movie mode is a mode in which monitor power control, lighting control and window control are performed at the same time. Such a mode can be set by a user or set by the controller 180.

Further, the mode can be displayed as a folder image on a page of the IOT. For example, as illustrated in the left drawing of FIG. 11A, the page of the IOT 400 may include a folder image indicating a ventilation mode and a folder image indicating a movie mode. Further, the controller 180 can execute a specific mode based on a touch input applied to a folder image indicating a specific mode. More specifically, the controller 180 can execute a plurality of functions contained in a specific mode at the same time based on a touch applied to a folder image indicating a specific mode.

For example, as illustrated in the right drawing of FIG. 11A, the controller 180 can open or close the living room window, balcony window and kitchen window included in a ventilation mode at the same time in response to a touch applied to a folder image 1200 indicating the ventilation mode. In other words, the controller 180 can apply a touch input to a folder image to execute a plurality of functions at the same time.

When the specific mode is performed, the controller 180 can display notification information indicating that the specific mode has been performed on the display unit 151. For example, as illustrated in the right drawing of FIG. 11A, the controller 180 can display a popup window 1240 indicating that a ventilation mode has been performed.

Alternatively, the controller 180 can execute a folder open function indicating icons contained in a folder based on a touch input applied to a folder image indicating a specific mode. The folder open function is a function of displaying icons contained in a folder. In this instance, icons contained in a folder may be displayed. For example, as illustrated in the upper right drawing of FIG. 11A, the controller 180 can display an image performing control for the living room window 1220a, balcony window 1220b and kitchen window 1220c, respectively, contained in a ventilation mode in response to a touch applied to the folder image 1200 indicating the ventilation mode.

When a folder open function is performed to display icons contained in each folder, the controller 180 can display an executable state or non-executable state of each function. For example, as illustrated in the second drawing of FIG. 11B, the controller 180 can display graphic objects 1220a, 1220c indicating a currently executable function with a thick edge and a graphic object 1220b indicating a non-executable function with a thin edge. Accordingly, a user intuitively can recognize currently executable functions and non-executable functions.

Furthermore, when a folder open function is performed, the controller 180 can display a graphic object 1230 for a specific mode execution. The graphic object 1230 may include a button for the ON/OFF of a specific mode. The user can execute a specific mode using the ON or OFF button of the graphic object 1230.

If a touch is applied to the ON button, then the controller 180 can execute a specific mode. In this instance, the controller 180 can open the living room window, balcony window and kitchen window at the same time. When the specific mode is performed, the controller 180 can change the visual appearance of a folder image indicating a specific mode. For example, as illustrated in the third drawing of FIG. 11B, when a ventilation mode is performed, the controller 180 can change the color of the folder image indicating a ventilation mode to a dark color. Thus, the user can recognize that a ventilation mode is being performed.

Furthermore, when a touch is applied to the OFF button, the controller 180 can end a specific mode. In this instance, the controller 180 can close the living room window, balcony window and kitchen window at the same time. Further, the controller 180 can end a specific mode based on a user's request or preset condition being satisfied. In this instance, it is possible to end a plurality of functions contained in a specific mode at the same time.

For example, as illustrated in FIG. 12, when a video playback is ended in a movie mode, the controller 180 can display notification information 1300 for ending the movie mode. Further, a user can apply a control command for ending the movie mode. In this instance, the controller 180 can end a plurality of functions provided in a movie mode at the same time. Thus, the user can execute a plurality of functions at the same time through only a one time control command.

Hereinafter, when a connection to an external device is ended for an application being connected and executed to the external device will be described. In particular, FIG. 13 is a conceptual view illustrating a method of controlling when a connection to an external device is ended for an application being connected and executed to the external device.

The controller 180 can sense a communication state with a specific external device in real time when a specific application is being connected and executed to a specific external device. The communication state may be either one state between a communication enabled state or communication disabled state to the specific external device.

For a communication enabled state, the controller 180 can continue to perform communication with a specific external device. For a communication disabled state, the controller 180 can suspend the execution of the specific application. In this instance, the controller 180 can reconnect it to another external device to execute the specific application.

For example, when a music application is connected to a living room speaker, the controller 180 can sense that communication with the living room speaker is in a disabled state. In this instance, the controller 180 can suspend the playback of music currently being played back on the music application.

Further, the user can connect another external device to the music application using an app list of applications that have been recently executed. For example, as illustrated in FIG. 13, an external device list 1310 including connectable external devices may be displayed based on a touch input applied to an image 1300 indicating a music application contained in an app list.

A user can select any external device contained in the external device list 1310. When the external device is selected, the controller 180 can execute the music application again through communication with the external device. For example, the device may be a bathroom speaker. Further, the controller 180 can restart playback from a time point at which the playback was suspended. Accordingly, the user can receive continuous content.

The present disclosure provides a page of the IOT that provides a function of automatically connecting between things and an application of a mobile terminal to conveniently control the things through communication. Thus, a user can conveniently connect an application to an external device using a page of the IOT, and execute an application installed on a mobile terminal using an external device.

In addition, the controller 180 can conveniently connect or release an application to or from an external device through the operation of adding or deleting an icon of the application on a page of the IOT. The present disclosure can also collectively display functions associated with the IOT on one page, thereby providing a more convenient experience to the user.

The foregoing present invention may be implemented as codes readable by a computer on a medium written by the program. The computer-readable media may include all kinds of recording devices in which data readable by a computer system is stored. Examples of the computer-readable media may include hard disk drive (HDD), silicon disk drive (SDD), solid state disk (SSD), ROM, RAM, CD-ROM, magnetic tape, floppy disk, and optical data storage device, and the like, and also include a device implemented in the form of a carrier wave (for example, transmission via the Internet). In addition, the computer may include the controller 180 of the terminal. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

What is claimed is:

1. A mobile terminal, comprising:
a wireless communication processor configured to provide wireless communication;
a touchscreen configured to display a home screen page; and
a controller configured to:
display an Internet Of Things (IOT) page instead of the home screen page in response to a preset touch input on the home screen page, wherein the IOT page includes at least one icon for executing an application on a specific external device, and
in response to an execution request of the displayed icon on the IOT page, transmit information associated with the application to the specific external device through the wireless communication processor to execute the application on the specific external device.

2. The mobile terminal of claim 1, wherein the home screen page includes an icon for executing the application on the mobile terminal, and
wherein the controller is further configured to execute the application on the mobile terminal in response to an execution request of the icon displayed on the home screen page.

3. The mobile terminal of claim 1, wherein the specific external device includes at least one of an external device capable of currently performing communication with the mobile terminal, an external device linked to an application, and an external device for which identification information is stored in a memory of the mobile terminal.

4. The mobile terminal of claim 1, wherein the controller is further configured to:
add an application installed on the mobile terminal onto the IOT page in response to a control command for adding the application, and
link the application to the specific external device to execute the application on the specific external device when the application is added onto the IOT page.

5. The mobile terminal of claim 4, wherein when the application is added onto the IOT page, the controller is further configured to display at least one candidate device that can be set to the specific external device in a vicinity of a region displayed with the icon of the application.

6. The mobile terminal of claim 1, wherein the controller is further configured to:
delete the at least one icon for executing the application on the specific external device from the IOT page in response to a delete request for the icon, and
release a communication link to the specific external device when the icon is deleted.

7. The mobile terminal of claim 1, wherein the controller is further configured to display a notification window including notification information associated with the IOT page in response to a preset type of touch applied to the IOT page.

8. The mobile terminal of claim 7, wherein the notification window comprises a first region displaying notification information associated with the IOT page and a second region displaying notification information associated with home screen page.

9. The mobile terminal of claim 1, wherein the home screen page comprises an identification information region including identification information of the home screen page and identification information of the IOT page, and
wherein the controller is further configured to distinguishingly display the identification information of the IOT page from the identification information of the home screen page.

10. The mobile terminal of claim 9, wherein the controller is further configured to display a graphic object indicating the identification information of the IOT page to have an animation effect when an event occurs with an application of an icon contained in the IOT page.

11. The mobile terminal of claim 1, wherein the IOT page includes a folder image corresponding to a folder containing a plurality of applications, and
wherein the controller is further configured to sequentially or concurrently execute the plurality of applications contained in the folder in response to a touch input applied to the folder image.

12. The mobile terminal of claim 1, wherein the controller is further configured to display an app list including previously executed application on the touchscreen in response to a control command for displaying the app list when the IOT page is displayed, and
wherein the app list comprises an item corresponding to an application that has been executed on the IOT page and an item corresponding to an application that has been executed on home screen page.

13. The mobile terminal of claim 12, wherein the controller is further configured to change the specific external device linked to an application of a selected item in the app list to another external device so the application is output on the other external device.

14. The mobile terminal of claim 12, wherein the controller is further configured to display candidate devices for allowing the execution of an application of a selected item in the app list based on a preset type of touch input applied to the selected item.

15. The mobile terminal of claim 14, wherein the controller is further configured to:
display graphic objects corresponding to specific external devices, and
transmit information associated with the execution of the application to one of the specific external devices based on a direction of a drag input on one of the graphic objects.

16. A method of controlling a mobile terminal, the method comprising:
displaying, via a touchscreen of the mobile terminal, a home screen page;
displaying, via the touchscreen, an Internet Of Things (IOT) page instead of the home screen page in response to a preset touch input on the home screen page, wherein the IOT page includes at least one icon for executing an application on a specific external device; and
in response to an execution request of the displayed icon on the IOT page, transmitting, via a controller controlling a wireless communication processor, information associated with the application to the specific external device through the wireless communication processor to execute the application on the specific external device.

17. The method of claim 16, wherein the home screen page includes an icon for executing the application on the mobile terminal, and
wherein the method further comprises executing the application on the mobile terminal in response to an execution request of the icon displayed on the home screen page.

18. The method of claim 16, wherein the specific external device includes at least one of an external device capable of currently performing communication with the mobile terminal, an external device linked to an application, and an external device for which identification information is stored in a memory of the mobile terminal.

19. The method of claim 16, further comprising:
adding an application installed on the mobile terminal onto the IOT page in response to a control command for adding the application; and
linking, via the controller, the application to the specific external device to execute the application on the specific external device when the application is added onto the IOT page.

20. The method of claim 19, wherein when the application is added onto the IOT page, the method further comprises displaying at least one candidate device that can be set to the specific external device in a vicinity of a region displayed with the icon of the application.
